(19) United States
(12) Patent Application Publication
(10) Pub. No.: US 2026/0116656 A1
(43) Pub. Date: Apr. 30, 2026

(54) SYSTEMS AND METHODS FOR CONTROLLER PRIORITY FOR CART DETECTION SYSTEM FOR A REFUSE VEHICLE

(71) Applicant: Oshkosh Corporation, Oshkosh, WI (US)

(72) Inventors: Brendan Chan, Oshkosh, WI (US); Roberto Santana Blanco, Oshkosh, WI (US); Leo Van Kampen, Conestogo (CA); Vince Schad, Oshkosh, WI (US); Joseph Wigle, Oshkosh, WI (US); Todd Cannon, Oshkosh, WI (US)

(73) Assignee: Oshkosh Corporation, Oshkosh, WI (US)

(21) Appl. No.: 19/368,185

(22) Filed: Oct. 24, 2025

Related U.S. Application Data
(60) Provisional application No. 63/712,050, filed on Oct. 25, 2024.

(51) Int. Cl. B65F 3/04; B60W 60/00; B65F 3/02

(52) U.S. Cl. CPC B65F 3/04; B60W 60/00; B65F 2003/0269; B65F 2003/0283

(57) ABSTRACT

A refuse vehicle includes an autonomous driving system configured to drive the refuse vehicle via a prime mover, a body assembly, a lift system configured to collect refuse into the body assembly, an autonomous refuse collection system configured to operate the lift system, and a controller communicably coupled to the lift system and the prime mover. The controller is configured to transmit a first signal to the autonomous driving system to control the lift system, where the first signal indicates initiation of an autonomous refuse collection operation via the lift system to collect refuse from a refuse can; transmit a second signal from a manual control interface of the refuse vehicle to the autonomous driving system to control the lift system, where the second signal indicates a manual control command for the lift system; and prioritize, via the autonomous driving system, the second signal over the first signal.

### CROSS REFERENT TO RELATED APPLICATIONS

This application claims the benefit of and priority to U.S. Provisional Patent Application No. 63/712,050, filed Oct. 25, 2024, the entire contents of which are incorporated by reference herein.

### BACKGROUND

This disclosure relates to waste-collection vehicles such as refuse vehicles, and in particular, to systems and methods for autonomous waste collection.

### SUMMARY

An exemplary embodiment relates to a refuse vehicle including a chassis, one or more tractive elements rotatably coupled to the chassis, a prime mover configured to power the one or more tractive elements to drive the refuse vehicle, an autonomous driving system configured to control the prime mover, a body assembly coupled to the chassis, where the body assembly defines a refuse compartment, a lift system configured to collect and deposit refuse into the refuse compartment of the body assembly, an autonomous refuse collection system configured to generate commands to cause operation of the lift system, and a controller communicably coupled to the lift system and the prime mover. The controller is configured to transmit a first signal to the autonomous driving system of the refuse vehicle to control the lift system, where the first signal is indicative of initiation of an autonomous refuse collection operation via the lift system to engage and collect refuse from a refuse can. The controller is further configured to transmit a second signal from a manual control interface of the refuse vehicle to the autonomous driving system to control the lift system, where the second signal is indicative of a manual control command for the lift system. The controller is further configured to prioritize, via the autonomous driving system, the second signal over the first signal.

In some embodiments, the controller is further configured to cease transmission of the first signal from the autonomous refuse collection system, based on the second signal. In some embodiments, the controller is further configured to transmit control signals from the autonomous refuse collection system, based on the first signal, to the lift system to autonomously engage and collect refuse from the refuse can via the lift system.

In some embodiments, the manual control interface is configured to receive a first user input to initiate transmission of the first signal from the autonomous refuse collection system. In some embodiments, the manual control interface is configured to receive a second user input, different from the first user input, to initiate manual control of the lift system via the manual control interface. In some embodiments, the manual control interface includes a joystick configured to operate the refuse vehicle manually.

Another exemplary embodiment relates to a system including an autonomous driving system, an autonomous refuse collection system, a lift system, a manual control interface, and a controller in communication with the autonomous driving system, the autonomous refuse collection system, the lift system, and the manual control interface. The controller is configured to receive a first signal from the manual control interface, and based on the first signal, communicably couple the autonomous refuse collection system to the lift system. The controller is further configured to receive a second signal from the manual control interface, and based on the second signal, communicably couple the manual control interface to the lift system while blocking communication between the autonomous refuse collection system and the lift system.

In some embodiments, transmitting the first signal is indicative of initiation of an autonomous refuse collection operation. In some embodiments, the lift system includes a hydraulic controller, where the autonomous driving system is configured to transmit control signals to the hydraulic controller to actuate the lift system to complete the autonomous refuse collection operation. In some embodiments, transmitting the second signal includes one or more control signals to manually control a driveline to manually control the lift system.

In some embodiments, the system further includes a relay communicably coupled to the manual control interface, autonomous refuse collection system and the autonomous driving system. The relay is configured to switch communication between the autonomous driving system and (i) the autonomous refuse collection system, or (ii) the manual control interface. In some embodiments, the system further includes a monitoring module communicably coupled to the relay. The monitoring module is configured to cause the relay to switch communication based on the manual control interface transmitting the second signal or a loss of signal from the autonomous refuse collection system. In some embodiments, the system further includes a status indicator communicably coupled to the autonomous refuse collection system. The status indicator is configured to indicate an operational status of the autonomous refuse collection system to an operator of the lift system, where, based on the status indicator indicating a non-operable status for the autonomous refuse collection system, the manual control interface transmits the second signal via user input from the operator to the manual control interface.

Another exemplary embodiment relates to method including transmitting a first signal to an autonomous driving system, where the first signal is indicative of initiation of an autonomous refuse collection operation via a lift system; transmitting a second signal from a manual control interface to the autonomous driving system, where the second signal is indicative of manual control of the lift system; and prioritizing, via the autonomous driving system, the second signal over the first signal.

In some embodiments, the method further includes transmitting control signals from an autonomous refuse collection system, based on the first signal, to the lift system to autonomously complete a refuse collection operation. In some embodiments, the method further includes transmitting control signals to the lift system to complete the refuse collection operation, where the lift system is manually controlled by the manual control interface based on the second signal.

In some embodiments, transmitting the first signal to the autonomous driving system includes receiving a first user input via the manual control interface to initiate transmission of the first signal from an autonomous refuse collection system. In some embodiments, transmitting the second signal from the manual control interface includes receiving a second user input via the manual control interface, where the second user input is different from the first user input, and the second user input initiates manual control of the lift system.

In some embodiments, the method further includes transmitting the second signal from the manual control interface to the autonomous refuse collection system, where the second signal is indicative of manual control of the lift system. In some embodiments, the method further includes ceasing transmission of the first signal from the autonomous refuse collection system, based on the second signal.

Further aspects and advantages of the embodiments described herein will appear from the following description taken together with the accompanying drawings.

### BRIEF DESCRIPTION OF THE FIGURES

The disclosure will become more fully understood from the following detailed description, taken in conjunction with the accompanying figures, wherein like reference numerals refer to like elements, in which:

FIG. 1A is a perspective view of a side loading refuse vehicle, according to an exemplary embodiment;

FIG. 1B is a perspective view of a front loading refuse vehicle, according to an exemplary embodiment;

FIG. 2A is a perspective view of a first type of actuator assembly for use with a refuse vehicle, according to an exemplary embodiment;

FIG. 2B is a perspective view of a second type of actuator assembly for use with a refuse vehicle, according to an exemplary embodiment;

FIG. 3A is a perspective view of a front loading refuse vehicle, according to another exemplary embodiment;

FIG. 3B is a perspective view of a front loading refuse vehicle, according to still another exemplary embodiment;

FIG. 3C is a perspective view of a side loading refuse vehicle, according to another exemplary embodiment;

FIG. 4 a block diagram of a control system for autonomous control of a refuse vehicle, according to an exemplary embodiment;

FIG. 5 is a block diagram of a vehicle autonomy system for use with a refuse vehicle, according to an exemplary embodiment;

FIGS. 6A-6C are top views of a refuse vehicle showing different coverage zones of sensor and cameras for at least one spatial awareness system of the refuse vehicle, according to various exemplary embodiments;

FIG. 7 is a flow diagram of a method for detecting refuse cans, according to an exemplary embodiment;

FIG. 8A is a chart indicating a method for determining a position of a refuse can, according to an exemplary embodiment;

FIG. 8B is a block diagram for determining a trajectory of a refuse vehicle based on a position of a refuse can, according to an exemplary embodiment;

FIGS. 9A-9D are example user interfaces for presenting a determined trajectory and/or refuse can detection for a refuse vehicle, according to various exemplary embodiments;

FIG. 10 is a block diagram of a control system for manual and autonomous operation of a refuse vehicle, according to an exemplary embodiment;

FIG. 11 is a block diagram of a control system for manual and autonomous operation of a refuse vehicle, according to an exemplary embodiment; and

FIG. 12 is a flow diagram of a method for prioritizing signals to a refuse vehicle, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Refuse vehicles collect a wide variety of refuse, waste, trash, and other material from residences and/or businesses. Operators of refuse vehicles transport the material from various waste receptacles within a municipality to a storage or processing facility (e.g., a landfill, an incineration facility, a recycling facility, etc.). The process of refuse collection generally includes picking up a receptacle, such as a refuse can, moving it to the hopper or bin of a refuse vehicle, dumping the contents of the receptacle into the hopper or bin of the refuse vehicle, and then returning the receptacle to its original location. Existing refuse vehicles may be operated by a team of at least two waste-collection personnel. One person/operator drives the refuse vehicle from one location to the next (e.g. from one house to the next), and then stops the refuse vehicle while the other person/operator (or persons/operators) walk to the location of the receptacle, manually pick up the receptacle, carry it to the refuse vehicle, dump the contents of the receptacle into the refuse vehicle, and then return the receptacle to the place from where it was first picked up.

This process may be improved by the addition of autonomous driving systems to the refuse vehicle to assist in transit operations and autonomous refuse collection systems which may enable autonomous or semi-autonomous operation of one or more controllable mechanical components (e.g., an arm, a lift assembly, etc.) mounted to the refuse vehicle. The mechanical components may be movable based on the autonomous refuse collection system or by manual joystick operation of a human operator. As such, the refuse vehicle could be driven from one location to another and maneuvered within close proximity of the waste receptacle by the autonomous driving system or a human operator, and the controllable mechanical components could be deployed through the autonomous refuse collection system or by joystick control in order to grasp, lift, and dump the waste receptacle.

Embodiments of the present disclosure relate to systems and methods for controlling the interaction between the autonomous and manual systems of the refuse vehicle and determining a priority of control over the refuse vehicle for the systems.

Referring generally to the Figures, vehicles, systems, and/or methods for transmitting, receiving, and prioritizing signals to and from a refuse vehicle, such as between (1) an autonomous driving system, (2) an autonomous refuse collection system, and (3) a manual control interface/system (e.g., a joystick) are shown. In some embodiments, both the autonomous refuse collection system and the autonomous driving system may be configured to receive signals from the manual control interface, and to selectively enable or override control operations being performed by the autonomous refuse collection system based on the signals. For example, the autonomous refuse collection system may be configured to prioritize manual control signals from the joystick of the refuse vehicle over commands received from the autonomous refuse collection system. The autonomous refuse collection system may also be configured to receive control signals from the joystick. For example, the autonomous refuse collection system may be configured to automate collection operations of a lift system responsive to a first signal from the joystick (e.g., pressing and holding the trigger of the joystick), and to cease operations responsive to the absence of the first signal, and/or responsive to a second signal from the joystick. The autonomous refuse collection system may also be communicably coupled to the autonomous driving system and may be configured to transmit a control signal to the autonomous driving system independent from the joystick concerning an operating state of the autonomous refuse collection system. Such an arrangement provides system redundancy with respect to moving components (e.g., the lift system) of the refuse vehicle, and ensures priority of manual control over autonomous vehicle functions. Thereby, refuse vehicles configured with such a system provides a higher refuse vehicle operational performance (e.g., more accurate refuse collection from refuse cans, decreased error and/or waste, etc.).

### Refuse Vehicle System

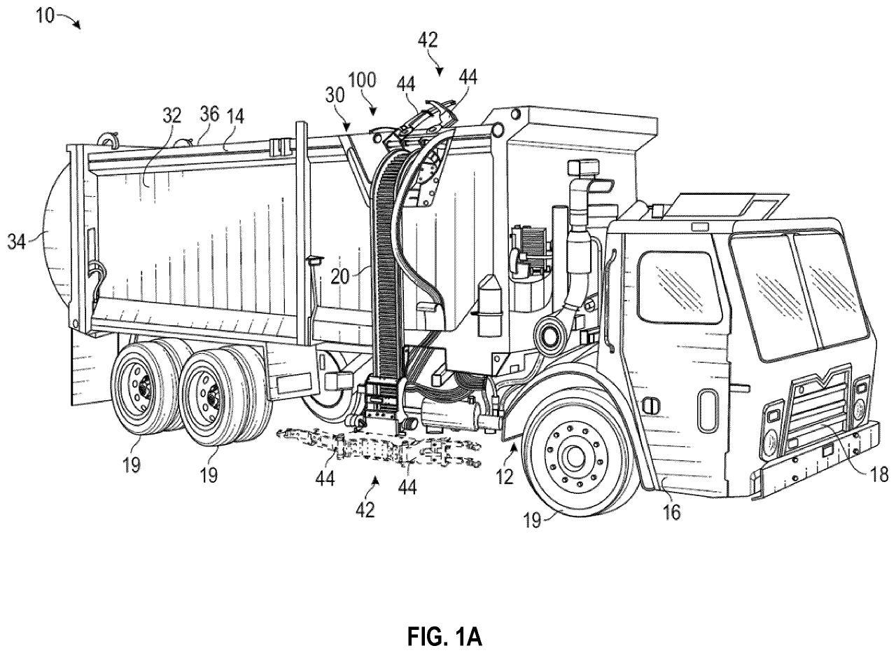

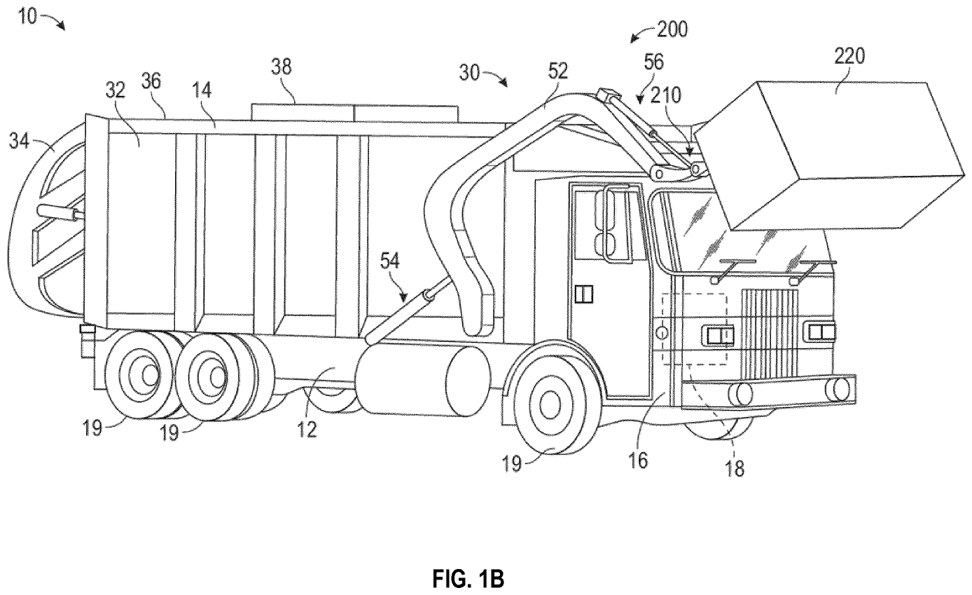

Referring now to FIGS. 1A and 1B, a refuse vehicle 10 is shown, according to some embodiments. Refuse vehicle 10 may be a garbage truck, a waste collection truck, a sanitation truck, etc., and may be configured as a side-loading refuse vehicle (e.g., as shown in FIG. 1A), front loading refuse vehicle (e.g., as shown in FIG. 1B), or a rear-loading refuse vehicle. In other embodiments, refuse vehicle 10 is another type of vehicle (e.g., a skid-loader, a telehandler, a plow truck, a boom lift, etc.). As shown, refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator, such as a seat, a steering wheel, hydraulic controls, a graphical user interface (e.g., a touchscreen user interface), switches, buttons, dials, etc.

As shown, refuse vehicle 10 includes a prime mover, shown as engine 18, coupled to the frame 12 at a position beneath the cab 16. Engine 18 is configured to provide power to a series of tractive elements, shown as wheels 19, and/or to other systems of refuse vehicle 10 (e.g., a pneumatic system, a hydraulic system, etc.). Engine 18 may be configured to utilize one or more of a variety of fuels (e.g., gasoline, diesel, bio-diesel, ethanol, natural gas, etc.), according to various exemplary embodiments. According to an alternative embodiment, engine 18 additionally or alternatively includes one or more electric motors coupled to frame 12 (e.g., a hybrid refuse vehicle, an electric refuse vehicle, etc.). The electric motors may consume electrical power from an on-board storage device (e.g., batteries, ultracapacitors, etc.), from an on-board generator (e.g., an internal combustion engine, etc.), and/or from an external power source (e.g., overhead power lines, etc.) and provide power to the systems of refuse vehicle 10.

In some embodiments, refuse vehicle 10 is configured to transport refuse from various waste receptacles within a municipality to a storage and/or processing facility (e.g., a landfill, an incineration facility, a recycling facility, etc.). As shown, the body 14 includes a plurality of panels, shown as panels 32, a tailgate 34, and a cover 36. In some embodiments, as shown in FIG. 1B, body 14 further includes a door, shown as top door 38, which is movably coupled along cover 36 to seal the opening thereby preventing refuse from escaping the refuse compartment 30 (e.g., due to wind, bumps in the road, etc.). Panels 32, tailgate 34, cover 36, and/or door 38 define a collection chamber (e.g., hopper, etc.), shown as refuse compartment 30. Loose refuse may be placed into refuse compartment 30 where it may thereafter be compacted. Refuse compartment 30 may provide temporary storage for refuse during transport to a waste disposal site and/or a recycling facility. In some embodiments, at least a portion of body 14 and refuse compartment 30 extend in front of cab 16. In some embodiments, body 14 and refuse compartment 30 are positioned behind cab 16.

In some embodiments, refuse compartment 30 includes a hopper volume and a storage volume. Refuse may be initially loaded into the hopper volume and thereafter compacted into the storage volume. According to an exemplary embodiment, the hopper volume is positioned between the storage volume and cab 16 (e.g., refuse is loaded into a position of refuse compartment 30 behind cab 16 and stored in a position further toward the rear of refuse compartment 30). In other embodiments, the storage volume is positioned between the hopper volume and cab 16 (e.g., a rear-loading refuse vehicle, etc.).

As shown in FIG. 1A, refuse vehicle 10, when configured as a side-loading refuse vehicle, may include a side-loading lift mechanism/system (e.g., a side-loading lift assembly), shown as lift assembly 100. Lift assembly 100 includes a grabber assembly, shown as grabber assembly 42, slidably coupled to a guide, shown as track 20, and configured to move along an entire length of the track 20. Track 20 is shown to extend along substantially an entire height of the body 14 and is configured to cause the grabber assembly 42 to tilt or rotate near an upper height of the body 14. In other embodiments, the track 20 extends along substantially an entire height of the body 14 on a rear side of the body 14.

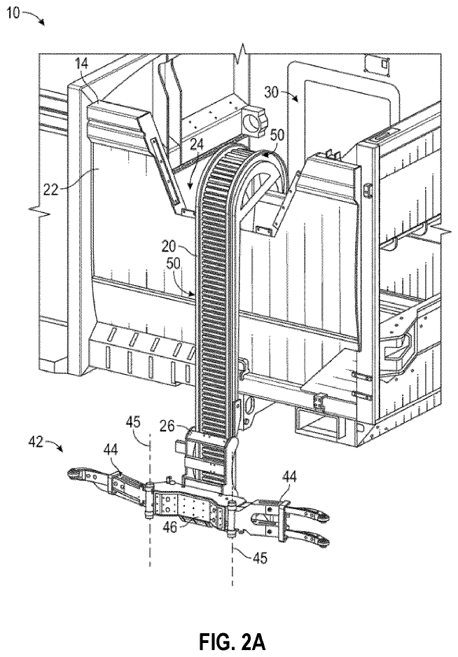

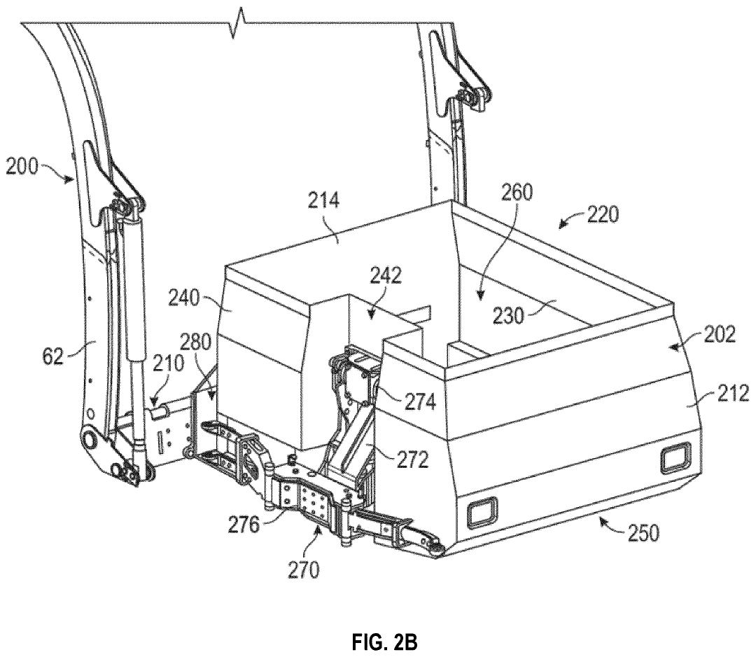

Grabber assembly 42 is shown to include a pair of actuators, shown as actuators 44. Actuators 44 are configured to releasably secure a refuse can to grabber assembly 42, according to an exemplary embodiment. Actuators 44 are selectively repositionable (e.g., individually, simultaneously, etc.) between an engaged position or state and a disengaged position or state. In the engaged position, actuators 44 are rotated towards one other such that the refuse can may be grasped therebetween. In the disengaged position, actuators 44 rotate outwards (e.g., as shown in FIG. 2A) such that the refuse can is not grasped by actuators 44. By transitioning between the engaged position and the disengaged position, actuators 44 releasably couple the refuse can to grabber assembly 42.

In operation, the refuse vehicle 10 may pull up alongside the refuse can, such that the refuse can is positioned to be grasped by the grabber assembly 42 therein. The grabber assembly 42 may then transition into an engaged state to grasp the refuse can. After the refuse can has been securely grasped, the grabber assembly 42 may be transported along the track 20 (e.g., by an actuator) with the refuse can. When the grabber assembly 42 reaches the end of track 20, grabber assembly 42 may tilt and empty the contents of the refuse can into the refuse compartment 30. The tilting is facilitated by the path of track 20. When the contents of the refuse can have been emptied into refuse compartment 30, the grabber assembly 42 may descend along track 20 and return the refuse can to the ground. Once the refuse can has been placed on the ground, the grabber assembly 42 may transition into the disengaged state, releasing the refuse can.

As shown in FIG. 1B, refuse vehicle 10, when configured as a front loading refuse vehicle, may include a front loading lift mechanism/system (e.g., a front loading lift assembly), shown as lift assembly 200. Lift assembly 200 includes a pair of arms, shown as lift arms 52, coupled to the frame 12 and/or the body 14 on either side of the refuse vehicle 10 such that the lift arms 52 extend forward of the cab 16 (e.g., a front loading refuse vehicle, etc.). In other embodiments, the lift assembly 200 extends rearward of the body 14 (e.g., a rear-loading refuse vehicle, etc.). In still other embodiments, the lift assembly 200 extends from a side of the body 14 (e.g., a side-loading refuse vehicle, etc.). The lift arms 52 may be rotatably coupled to frame 12 with a pivot (e.g., a lug, a shaft, etc.). As shown, the lift assembly 200 includes first actuators, shown as lift arm actuators 54 (e.g., hydraulic cylinders, etc.), coupled to the frame 12 and the lift arms 52. The lift arm actuators 54 are positioned such that extension and retraction thereof rotates the lift arms 52 about an axis extending through the pivot, according to an exemplary embodiment.

An attachment assembly 210 may be coupled to the lift arms 52 of the lift assembly 200. As shown, the attachment assembly 210 is configured to engage with a first attachment, shown as container attachment 220, to selectively and releasably secure the container attachment 220 to the lift assembly 200. In some embodiments, attachment assembly 210 may be configured to engage with a second attachment, such as a fork attachment, to selectively and releasably secure second attachment to the lift assembly 200. In various embodiments, attachment assembly 210 may be configured to engage with another type of attachment (e.g., a street sweeper attachment, a snow plow attachment, a snowblower attachment, a towing attachment, a wood chipper attachment, a bucket attachment, a cart tipper attachment, a grabber attachment, etc.).

As shown in FIG. 1B, the lift arms 52 are rotated by the lift arm actuators 54 to lift the container attachment 220 or other attachment over the cab 16. Lift assembly 200 includes second actuators, shown as articulation actuators 56 (e.g., hydraulic cylinders, etc.). In some embodiments, the articulation actuators 56 are positioned to articulate the attachment assembly 210. Such articulation may assist in tipping refuse out of the container attachment 220 and/or a refuse can (e.g., coupled to the lift assembly 200 by a fork attachment, etc.) and into the hopper volume of the refuse compartment 30 through an opening in the cover 36. The lift arm actuators 54 may thereafter rotate the lift arms 52 to return the empty container attachment 220 to the ground. In some embodiments, top door 38 is movably coupled along the cover 36 to seal the opening thereby preventing refuse from escaping the refuse compartment 30 (e.g., due to wind, bumps in the road, etc.).

Referring now to FIGS. 2A and 2B, detailed perspective views of lift assemblies for use with refuse vehicle 10 are shown, according to some embodiments. Specifically, FIG. 2A shows a detailed, perspective view of lift assembly 100, according to some embodiments. As described briefly above, lift assembly 100 includes track 20 and grabber assembly 42, which includes a frame, chassis, or connecting member, shown as carriage 26. The track 20 extends along substantially the entire height of the body 14, according to the exemplary embodiment shown. The body 14 includes a panel, shown as loading section 22, that defines a cutout or notch, shown as recess 24, through which the track 20 passes. The recess 24 facilitates a curved portion of the track 20 extending around the top of the loading section 22 without increasing the overall height of the vehicle 10. When the grabber assembly 42 moves along the curved portion of the track 20, the grabber assembly 42 is inverted to empty the refuse can releasably coupled to the grabber assembly 42 into the refuse compartment 30.

The carriage 26 is slidably coupled to the track 20. In operation, the carriage 26 may translate along a portion or all of the length of the track 20. The carriage 26 is removably coupled (e.g., by removable fasteners) to a body or frame of the grabber assembly 42, shown as grabber frame 46. Alternatively, the grabber frame 46 may be fixedly coupled to (e.g., welded to, integrally formed with, etc.) the carriage 26. The actuators 44 are each pivotally coupled to the grabber frame 46 such that they rotate about a pair of axes 45. The axes 45 extend substantially parallel to one another and are longitudinally offset from one another. In some embodiments, one or more actuators configured to rotate the actuators 44 between the engaged state and the disengaged state are coupled to the grabber frame 46 and/or the carriage 26.

Referring now to FIG. 2B, a detailed, perspective view of lift assembly 200 is shown, according to some embodiments. As shown, container attachment 220 includes a container, shown as refuse can 202; an articulating refuse collection arm, shown as collection arm assembly 270; and an interface, shown as attachment interface 280. The refuse can 202 has a first wall, shown as front wall 212; an opposing second wall, shown as rear wall 214 (e.g., positioned between the cab 16 and the front wall 212, etc.); a first sidewall, shown as first sidewall 230; an opposing second sidewall, shown as second sidewall 240; and a bottom surface, shown as bottom 250. The front wall 212, the rear wall 214, the first sidewall 230, the second sidewall 240, and the bottom 250 cooperatively define an internal cavity, shown as container refuse compartment 260. According to an exemplary embodiment, the container refuse compartment 260 is configured to receive refuse from a refuse can (e.g., a residential garbage can, a recycling bin, etc.).

As shown, the second sidewall 240 of the refuse can 202 defines a cavity, shown as recess 242. The collection arm assembly 270 is coupled to the refuse can 202 and may be positioned within the recess 242. In other embodiments, the collection arm assembly 270 is otherwise positioned (e.g., coupled to the rear wall 214, coupled to the first sidewall 230, coupled to the front wall 212, etc.). According to an exemplary embodiment, the collection arm assembly 270 includes an arm, shown as arm 272; a grabber assembly, shown as grabber 276, coupled to an end of the arm 272; and an actuator, shown as actuator 274. The actuator 274 may be positioned to selectively reorient the arm 272 such that the grabber 276 is extended laterally outward from and retracted laterally inward toward the refuse can 202 to engage (e.g., pick up, etc.) a refuse can (e.g., a garbage can, a reclining bin, etc.) for emptying refuse into the container refuse compartment 260.

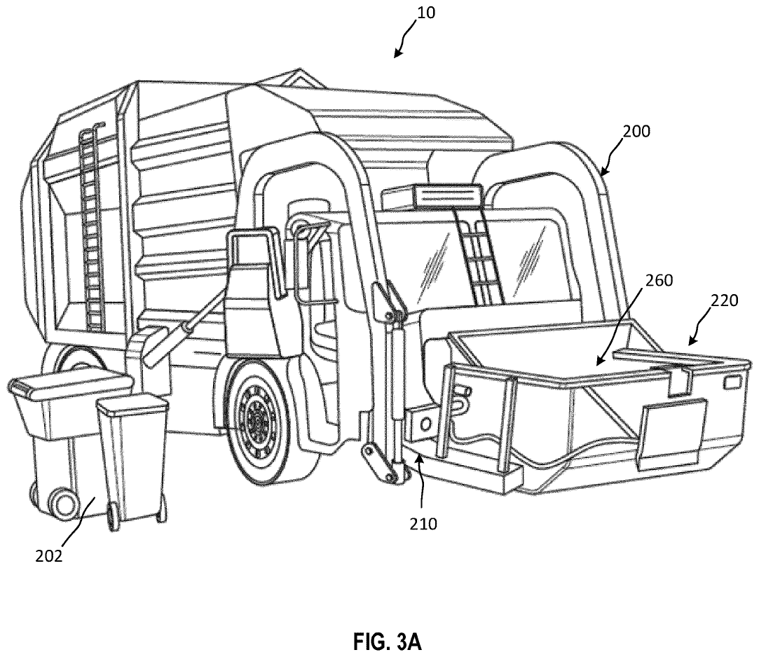

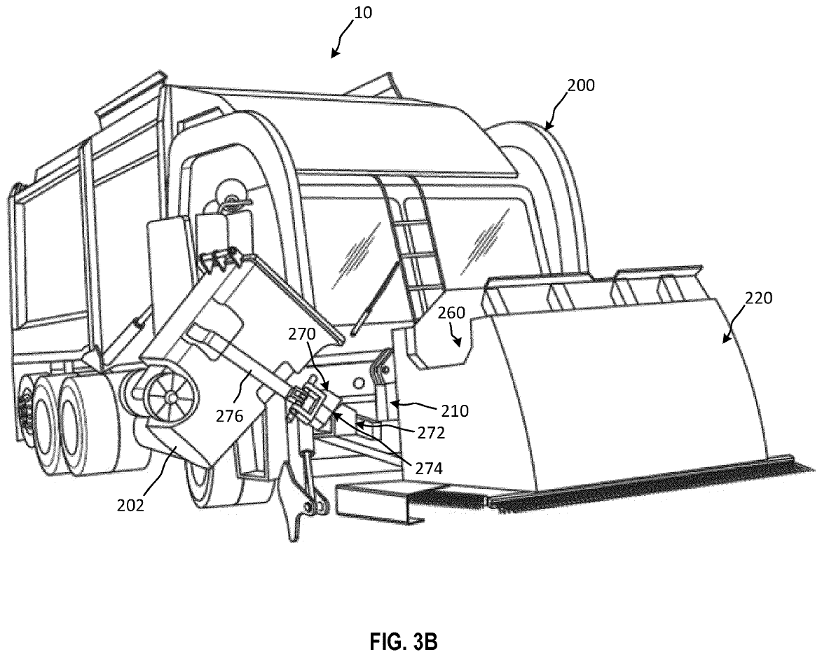

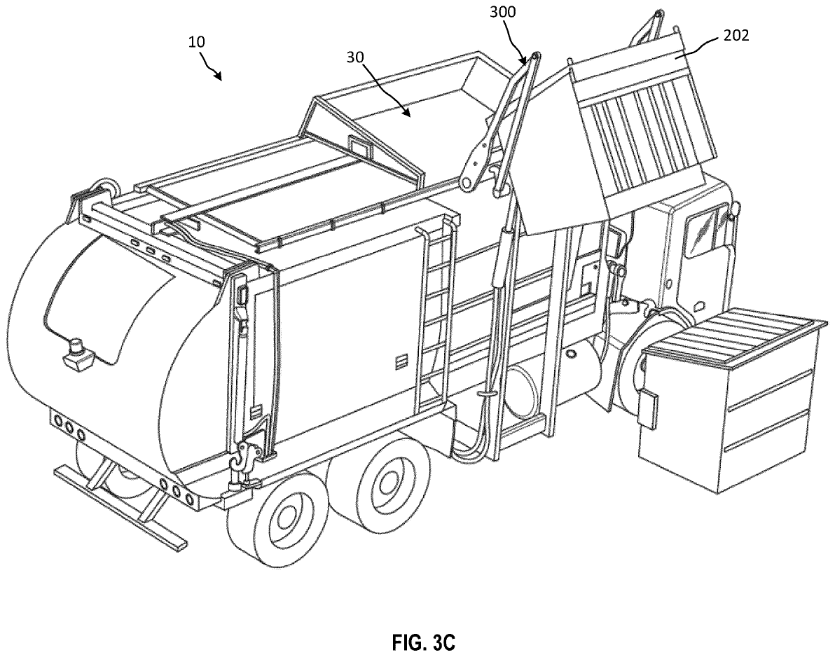

Referring now to FIGS. 3A-3C, example configurations of refuse vehicle 10 are shown, according to some embodiments. FIGS. 3A-3C may illustrate examples of potential configurations of refuse vehicle 10 in addition to the configurations described above with respect to FIGS. 1A-1B and 2A-2B. FIG. 3A illustrates a front loading configuration of refuse vehicle 10 with an intermediate storage container. For example, as shown in FIG. 3A, the refuse vehicle 10 may include the container attachment 220 to receive refuse (e.g., in the compartment 260), where the container attachment 220 is coupled to the refuse vehicle 10 via the attachment assembly 210. Refuse may be collected from one or more refuse cans 202 into the container attachment 220, where the lift assembly 200 moves the container attachment 220 to deposit refuse into the refuse vehicle 10 (e.g., the refuse compartment 30 thereof). FIG. 3B illustrates another front loading configuration of refuse vehicle 10 with an intermediate storage container that includes an actuator assembly (e.g., similar to container attachment 220). For example, the refuse vehicle 10 may include the container attachment 220 (e.g., coupled to the refuse vehicle 10 via the attachment assembly 210) to receive refuse (e.g., in the compartment 260). The container attachment 220 may include the collection arm assembly 270, where a refuse can 202 is engaged by the grabber 276 to deposit refuse into the compartment 260 of the container attachment 220 (e.g., by actuating the arm 272 using the actuator 274 of the collection arm assembly 270 to dump refuse from the refuse can 202). The lift assembly 200 moves the container attachment 220 (e.g., once full of refuse collected from refuse cans 202) to deposit refuse into the refuse vehicle 10 (e.g., the refuse compartment 30 thereof). FIG. 3C illustrates a side-loading configuration of refuse vehicle 10 (e.g., an auto side-loader) with a grabber-tipper assembly configured to engage an industrial or commercial refuse can. For example, the refuse vehicle 10 may include an actuator assembly 300, where the actuator assembly 300 is configured on a side of the refuse vehicle 10 and configured to collect refuse from a commercial and/or industrial refuse can 202. In some embodiments, the actuator assembly 300 may be similar to the lift assembly 200 and/or the grabber assembly 42. The actuator assembly 300 engages the refuse can 202 (e.g., via a grabber arm, via forks, etc.) and moves said refuse can 202 to deposit refuse into the refuse compartment 30 of the refuse vehicle 10. It will be appreciated that the configurations shown in FIGS. 3A-3C illustrate example configurations of refuse vehicle 10 and are not intended to be limiting. As described above, refuse vehicle 10 may be configured in any number of front, side, and/or rear-loading configurations, with any type of lift and/or grabber assembly for engaging a commercial or residential refuse can.

### Control System

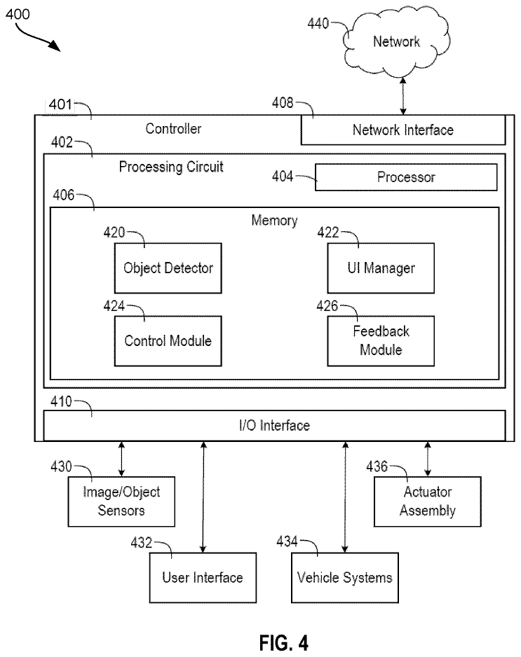

Referring now to FIG. 4, the refuse vehicle 10 (e.g., the autonomous refuse collection system) may include a control system 400, and/or control subsystems thereof, that is configured to facilitate autonomous or semi-autonomous operation of the refuse vehicle 10, or components thereof. The control system 400 includes a controller 401 that is positioned on the refuse vehicle 10, a remote computing system, a telematics unit, one or more input devices, and one or more controllable elements. The input devices can include a Global Positioning System (“GPS”), multiple sensors, a vision system (e.g., an awareness system), and a Human Machine Interface (“HMI”). The controllable elements can include a driveline of the refuse vehicle 10, a braking system of the refuse vehicle 10, a steering system of the refuse vehicle 10, a lift apparatus (e.g., the lift assembly 100, the lift assembly 200, etc.), a compaction system (e.g., a packer assembly, a packer, etc.), body actuators (e.g., tailgate actuators, lift or dumping actuators, etc.), and/or an alert system.

The controller 401 for refuse vehicle 10 is shown in FIG. 4, according to some embodiments. The controller 401 may be configured to receive data from image and/or object sensors (e.g., cameras and sensors) to detect and/or track a plurality of refuse can located on any side of a refuse vehicle (e.g., the front, sides, or rear of refuse vehicle 10). The controller 401 may be further configured to initiate automated control actions based on the detection of a refuse can. It will be appreciated that controller 401 may be implemented via single controller or may be implemented across multiple controllers or devices. In the embodiment of FIG. 4, the controller 401 is part of the automated refuse collection system for the refuse vehicle, but also includes functions that may be implemented by a controller of the autonomous driving system. As will be described in further detail below, operations of the controller related to the lifting system for engaging and emptying refuse cans/containers may be implemented or coordinated based on signals from a controller of the autonomous refuse collection system. Operations of the controller related to movement of the vehicle (e.g., transit operations, etc.) may be implemented or coordinated based on signals from a controller of the autonomous driving system.

Controller 401 may be one of one or more controllers of refuse vehicle 10, for example. Controller 401 generally receives and processes data from one or more image and/or object sensors disposed at various locations of refuse vehicle 10 to identify refuse cans located on at least the curb side of refuse vehicle 10. Controller 401 is shown to include a processing circuit 402 including a processor 404 and a memory 406. In some embodiments, processing circuit 402 is implemented via one or more graphics processing units (GPUs). Processor 404 can be implemented as a general purpose processor, an application specific integrated circuit (ASIC), one or more field programmable gate arrays (FPGAs), a group of processing components, or other suitable electronic processing components. In some embodiments, processor 404 is implemented as one or more graphics processing units (GPUs).

Memory 406 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 406 can be or include volatile memory or non-volatile memory. Memory 406 can include database components, object code components, script components, or any other type of information structure for supporting the various activities and information structures described in the present application. According to an example embodiment, memory 406 is communicably connected to processor 404 via processing circuit 402 and includes computer code for executing (e.g., by processing circuit 402 and/or processor 404) one or more processes described herein.

Processing circuit 402 can be communicably connected to a network interface 408 and an input/output (I/O) interface 410, such that processing circuit 402 and the various components thereof can send and receive data via interfaces 408 and 410. In some embodiments, controller 401 is communicably coupled with a network 440 via network interface 408, for transmitting and/or receiving data from/to network connected devices. Network 440 may be any type of network (e.g., intranet, Internet, VPN, a cellular network, a satellite network, etc.) that allows controller 401 to communicate with other remote systems. For example, controller 401 may communicate with a server (e.g., a computer, a cloud server, etc.) to send and receive information regarding operations of controller 401 and/or refuse vehicle 10.

Network interface 408 may include any type of wireless interface (e.g., antennas, transmitters, transceivers, etc.) for conducting data communications with network 440. In some embodiments, network interface 408 includes a cellular device configured to provide controller 401 with Internet access by connecting controller 401 to a cellular tower via a 2G network, a 3G network, an LTE network, etc. In some embodiments, network interface 408 includes other types of wireless interfaces such as Bluetooth, WiFi, Zigbee, etc.

In some embodiments, controller 401 may receive over-the-air (OTA) updates or other data from a remote system (e.g., a server, a computer, etc.) via network 440. The OTA updates may include software and firmware updates for controller 401, for example. Such OTA updates may improve the robustness and performance on controller 401. In some embodiments, the OTA updates may be received periodically to keep controller 401 up-to-date.

In some embodiments, controller 401 is communicably coupled to any number of subsystems and devices of refuse vehicle 10 via I/O interface 410. I/O interface 410 may include wired or wireless interfaces (e.g., antennas, transmitters, transceivers, wire terminals, etc.) for conducting data communications with subsystems and/or devices of refuse vehicle 10. In some embodiments, I/O interface 410 may include a Controller Area Network (CAN) bus, a Local Interconnect Network (LIN) bus, a Media Oriented Systems Transport (MOST) bus, an SAE Jl850 bus, an Inter-Integrated Circuit (12C) bus, etc., or any other bus commonly used in the automotive industry. As shown, I/O interface 410 may transmit and/or receive data from a plurality of vehicle subsystems and devices including image/object sensors 430, a user interface 432, vehicle systems 434, and/or an actuator assembly 436.

As described herein, image/object sensors 430 may include any type of device that is configured to capture data associated with the detection of objects such as refuse cans. In this regard, image/object sensors 430 may include any type of image sensors and/or object sensors, such as one or more visible light cameras, full-spectrum cameras, LIDAR cameras/sensors, radar sensors, infrared cameras, image sensors (e.g., charged-coupled device (CCD), complementary metal oxide semiconductor (CMOS) sensors, etc.), or any other type of suitable object sensor or imaging device. Data captured by image/object sensors 430 may include, for example, raw image data from one or more cameras (e.g., visible light cameras) and/or data from one or more sensors (e.g., LIDAR, radar, etc.) that may be used to detect objects.

Generally, image/object sensors 430 may be disposed at any number of locations throughout and/or around refuse vehicle 10 for capturing image and/or object data from any direction with respect to refuse vehicle 10. For example, image/object sensors 430 may include a plurality of visible light cameras and LIDAR cameras/sensors mounted on the forward and lateral sides of refuse vehicle 10 for capturing data as refuse vehicle 10 moves down a path (e.g., a roadway). In some embodiments, one or more of image/object sensors 430 may be located on an attachment utilized by refuse vehicle 10, such as container attachment 220 described above.

User interface 432 may be any electronic device that allows an operator to interact with controller 401. Examples of user interfaces or devices include, but are not limited to, mobile phones, electronic tablets, laptops, desktop computers, workstations, and other types of electronic devices. In some embodiments, user interface 432 is a control system (e.g., a control panel) configured to display information to an operator of refuse vehicle 10 and/or receive user inputs. In this regard, user interface 432 may include at least a display for presenting information to a user and a user input device for receiving user inputs. In one example, user interface 432 includes a touchscreen display panel located in the cab 16 of refuse vehicle 10 and configured to present an operator with a variety of information regarding the operations of refuse vehicle 10. User interface 432 may further include a user input device, such as a keyboard, buttons, etc., or a joystick (as discussed further herein).

Vehicle systems 434 may include any subsystem or device associated with refuse vehicle 10. Vehicle systems 434 may include, for example, powertrain components (e.g., prime mover 18), steering components, a grabber arm, lift assemblies, etc. Vehicle system 434 may also include electronic control modules, control units, and/or sensors associated with any systems, subsystems, and/or devices of refuse vehicle 10. For example, vehicle system 434 may include an engine control unit (ECU), a transmission control unit (TCU), a Powertrain Control Module (PCM), a Brake Control Module (BCM), a Central Control Module (CCM), a Central Timing Module (CTM), a General Electronic Module (GEM), a Body Control Module (BCM), an actuator or grabber assembly control module, etc. In this manner, any number of vehicle systems and devices may communicate with controller 401 via I/O interface 410.

Actuator assembly 436 may include at least the components of a lift assembly for engaging, lifting, and emptying a refuse can. Actuator assembly 436 can include, for example, any of the components of lift assembly 100 and/or lift assembly 200, described above with respect to FIGS. 1A and 1B. For example, actuator assembly 436 may include lift assembly 200, where a fork attachment is coupled to lift assembly 200 for engaging and lifting front loading refuse cans (e.g., industrial or commercial refuse cans, as shown in FIG. 1B). Actuator assembly 436 may include a plurality of actuators (e.g., linear actuators, lift actuators, horizontal actuators, etc.) for moving to engage the refuse can. As an example, actuator assembly 436 may be configured to move horizontally, vertically, orthogonally, etc., to refuse vehicle 10 in order to engage a refuse can. In some embodiments, actuator assembly 436 may further include an actuator assembly control module, configured to receive data and/or signals from controller 401 to initiate control actions for a grabber arm or actuator.

Still referring to FIG. 4, memory 406 is shown to include an object detector 420. Object detector 420 may generally receive and process data from image/object sensors 430 to detect objects (e.g., refuse cans). It will be appreciated that, has denoted herein, the data received and process by object detector 420 may include any type of data as described above with respect to image/object sensors 430, including video from which images and/or other image data can be extracted. As described above, the data may also include data from one or more sensors (e.g., LIDAR, radar, etc.) that may be utilized to detect an object (e.g., a refuse can) and/or a location or position of the object. As shown, for example, object detector 420 may receive data from image/object sensors 430 via I/O interface 410.

Object detector 420 may process the received data to detect target objects, including human beings and/or refuse cans. It will be appreciated, however, that object detector 420 may be configured to detect other objects based on other implementations of controller 401. In this regard, object detector 420 may provide means for controller 401 to detect and track a plurality of refuse cans on a path being traveled by refuse vehicle 10.

Object detector 420 may include a neural network or other similar model for processing received data (e.g., from image/object sensors 430) to detect target objects. As described herein, object detector 420 is generally a one-stage object detector (e.g., deep learning neural network), or may utilize a one-stage object detection method. Unlike two-stage object detectors (e.g., regional convolution neural network (R-CNN), Fast R-CNN, etc.), object detector 420 may process image data in a single stage and may provide advantages over many two-stage detectors such as increased speed (e.g., decreased computing time).

### Autonomous Driving System

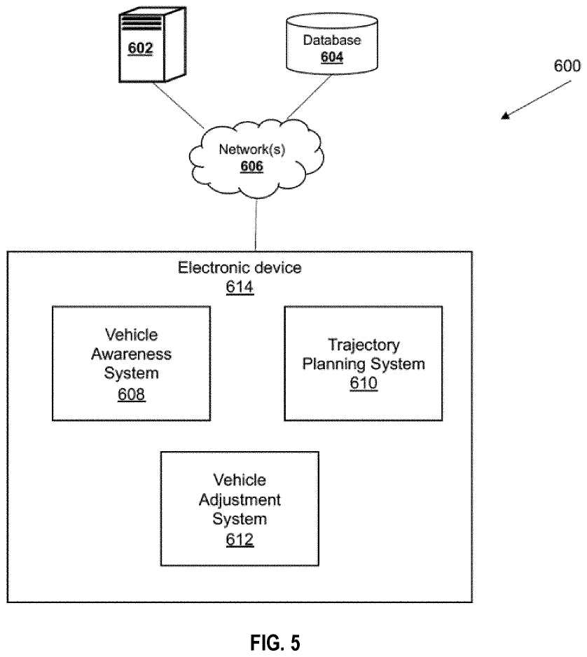

Referring now to FIG. 5, an autonomous driving system 600 (e.g., an autonomy system, etc.) for executing autonomous/semi-autonomous guidance of a vehicle (e.g., refuse vehicle 10) is shown with various components and subsystems. The autonomous driving system 600 may autonomously or semi-autonomously assist in transit operations, such as moving the refuse vehicle 10 from one location to another. For example, the autonomous driving system 600 may fully autonomously drive the refuse vehicle from a first location to a second location, such as from an initial location (e.g., a home location, a dumping location, etc.) to a first pick-up location. The autonomous driving system 600 may also fully autonomously maneuver the refuse vehicle 10 with respect to a target (e.g., a location, a refuse can, etc.), for example, turning or reversing the refuse vehicle 10 to move the refuse vehicle 10 into closer proximity to the target. In some embodiments, the autonomous driving system 600 may be a subsystem of the control system 400, as described herein.

The autonomous driving system 600 may include a server 602, a database 604, an electronic device 614. In some embodiments, the electronic device 614 is communicatively or physically coupled to the vehicle. The various devices and components of the autonomous driving system 600 may communicate with one another via one or more networks 606. In some embodiments, the autonomous driving system 600 may include a communication hub communicatively coupled to multiple vehicles and the various other components of the autonomous driving system 600 for facilitating communications between the various components of the autonomous driving system 600.

For ease of description and understanding, FIG. 5 depicts the autonomous driving system 600 as having only one or a small number of each component. Embodiments may, however, comprise additional or alternative components, or omit certain components, from those of FIG. 5 and still fall within the scope of this disclosure. As an example, it may be common for embodiments to include multiple servers 602 and/or multiple databases 604 that are communicably coupled to the server 602 and the electronic device 614 through the network 606. Embodiments may include or otherwise implement any number of devices capable of performing the various features and tasks described herein. For instance, FIG. 5 depicts the database 604 as hosted as a distinct computing device from the server 602, though, in some embodiments, the server 602 may include an integrated database 604 hosted by the server 602.

The autonomous driving system 600 includes one or more networks 606, which may include any number of internal networks, external networks, private networks (e.g., intranets, VPNs), and public networks (e.g., Internet). The networks 606 comprise various hardware and software components for hosting and conduct communications amongst the components of the autonomous driving system 600. Non-limiting examples of such internal or external networks 606 may include a Local Area Network (LAN), Wireless Local Area Network (WLAN), Metropolitan Area Network (MAN), Wide Area Network (WAN), and the Internet. The communication over the networks 606 may be performed in accordance with various communication protocols, such as Transmission Control Protocol and Internet Protocol (TCP/IP), User Datagram Protocol (UDP), and IEEE communication protocols, among others.

The electronic device 614 may include hardware components (e.g., one or more processors, non-transitory storage) and software components capable of performing the various processes and tasks described herein. Non-limiting examples of the electronic device 614 include personal computers (e.g., laptop computers, desktop computers), server computers, mobile devices (e.g., smartphones, tablets), VR devices, and gaming consoles, smart watches, vehicle control boards, among other types of electronic devices. In some embodiments, the electronic device 614 may be the controller 401 of FIG. 4.

The electronic device 614 may include one or more subsystems and/or modules that when executed by the electronic device 614 to cause the electronic device 614 to perform various processes and methods as described herein. For example, the electronic device 614 may include a vehicle awareness system 608, a trajectory planning system 610, and/or a vehicle adjustment system 612. Although shown as separate and discrete subsystems, the vehicle awareness system 608, the trajectory planning system 610, and/or the vehicle adjustment system 612 may be a single system or split into additional subsystems. The separation of the vehicle awareness system 608, the trajectory planning system 610, and/or the vehicle adjustment system 612 into discrete subcomponents with discrete configurations and executable processes is for clarity of the disclosures and should not be interpreted in any way as limiting to scope of the disclosure. In some embodiments, the vehicle awareness system 608, the trajectory planning system 610, and/or the vehicle adjustment system 612 may be stored and/or executed by the server 602 and/or the database 604.

The server 602 may execute one or more software programs (e.g., the vehicle awareness system 608, the trajectory planning system 610, and/or the vehicle adjustment system 612) to perform various methods and processes described herein. The server 602 may include one or more computing devices configured to perform various processes and operations disclosed herein. In some embodiments, the server 602 may be a computer or computing device capable of performing methods disclosed herein. The server 602 may include a processor and non-transitory, computer readable medium including instructions, which, when executed by the processor, caused the processor to perform methods disclosed herein. The processor may include any number of physical, hardware processors. Although FIG. 5 shows only a single server 602, the server 602 may include any number of computing devices. In some cases, the computing devices of the server 602 may perform all or portions of the processes and benefits of the server 602. The server 602 may comprise computing devices operating in a distributed or cloud computing configuration and/or in a virtual machine configuration. It should also be appreciated that, in some embodiments, functions of the server 602 may be partly or entirely performed by the electronic device 614.

In an example, the electronic device 614 may execute one or more software programs to perform various methods and processes described herein. The electronic device 614 may include one or more computing devices configured to perform various processes and operations disclosed herein. In some embodiments, the electronic device 614 may be a computer or computing device capable of performing methods disclosed herein. In some embodiments, the electronic device 614 may be a mobile computing device (e.g., cellular device or tablet). In other embodiments, the electronic device 614 is an onboard vehicle controller (e.g., controller 401 of FIG. 4). The electronic device 614 may include a processor and non-transitory, computer-readable medium including instructions, which, when executed by the processor, caused the processor to perform methods disclosed herein. The processor may include any number of physical, hardware processors. Although FIG. 5 shows only a single electronic device 614, the electronic device 614 any include any number of computing devices. In some cases, the computing devices of the electronic device 614 may perform all or portions of the processes and benefits of the electronic device 614. The electronic device 614 may comprise computing devices operating in a distributed or cloud computing configuration and/or in a virtual machine configuration.

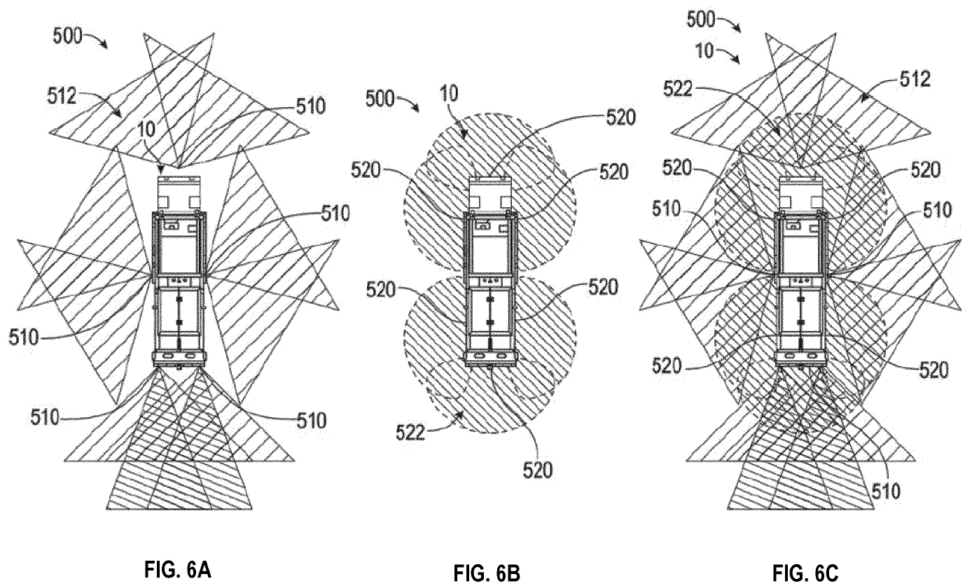

Turning now to FIGS. 6A-6C, an exemplary embodiment of a vehicle (e.g., the refuse vehicle 10 of FIG. 1A) including one or more processors executing a vehicle awareness system 500 is shown. The vehicle awareness system 500 may be substantially similar to the vehicle awareness system 608 of FIG. 5. The processors may be hosted locally on the refuse vehicle 10 and/or remotely (e.g., on the server 602 of FIG. 5). In one example, an autonomy system described herein may comprise several subsystems (e.g., the vehicle awareness system 500), components, processors, hardware, databases, servers, electronic device, instructions for execution etc. The described autonomy system may autonomously or semi-autonomously operate the vehicle based on various inputs. In an exemplary embodiment, the autonomy system includes the vehicle awareness system 500, as described in FIGS. 5-6C.

The autonomy system of the vehicle (e.g., the refuse vehicle 10) includes the vehicle awareness system 500 (e.g., a detection system, a vision system, an environmental detection system, an environmental awareness system, etc.) that is configured to detect and identify the environment surrounding the vehicle. The environment may include adjacent objects, approaching objects, lane lines, obstacles, drivable surfaces, etc. The vehicle awareness system 500 may be configured to detect different types of objects such as refuse containers, vehicles, buildings, fences, drainage, or any other object that may adjacent the refuse vehicle. The vehicle awareness system 500 may use a variety of sensors, detectors, emitters, detection sub-systems, etc., to detect different types of objects. For example, the vehicle awareness system 500 may use the vision system 128 or multiple of the sensors 126 of the refuse vehicle 10.

Referring still to FIGS. 6A-6C, the vehicle awareness system 500 may be configured to detect objects in a surrounding area of the refuse vehicle 10 that is proximate the refuse vehicle 10. In some embodiments, as shown in FIG. 6A, the vehicle awareness system 500 may include radar sensors 510 with sensing arcs 512 configured to detect objects in the surrounding area of the refuse vehicle 10. In some embodiments, the radar sensors 510 may be positioned on the exterior of the refuse vehicle 10 such that the sensing arcs 512 of the radar sensors 510 overlap to generate a 360-degree sensing area. In some embodiments, the radar sensors 510 are a combination of long and short-range sensors.

In some embodiments, as shown in FIG. 6B, the vehicle awareness system 500 may include camera sensors 520 with sensing arcs 522. In some embodiments, the camera sensors 520 may be a visible light camera and/or an infrared light camera, which be positioned on the exterior of the refuse vehicle 10 such that the sensing arcs 522 of the camera sensors 520 overlap to generate a 360-degree sensing area. In some embodiments, the camera sensors 520 are a combination of narrow-angle sensors and wide-angle sensors.

In some embodiments, as shown in FIG. 6C, the vehicle awareness system 500 may include a combination of the radar sensors 510 with the sensing arcs 512 and the camera sensors 520 with the sensing arcs 522. The sensing arcs 512 of the radar sensors 510 and the sensing arcs 522 of the camera sensors 520 may combine to provide 360 or near-360-degree coverage of the perimeter of the vehicle. Additional or alternative sensors may be used in the vehicle awareness system 500. For example, the vehicle awareness system 500 may employ LiDAR sensors, ultrasonic sensors, time-of-flight sensors, infrared light sensors, etc.

It should be understood that the positioning and arrangement of the radar sensors 510 and the camera sensors 520 as described herein with reference to FIGS. 6A-6C is illustrative only and is not intended to be limiting. For example, any of the radar sensors 510 or the camera sensors 520 may be disposed on a top of the refuse vehicle 10 such that the radar sensors 510 or the camera sensors 520 are configured to detect the presence and relative distance or position of overhead objects, obstacles, etc., proximate the refuse vehicle 10. The vehicle awareness system 500 may additionally process the perceived environment data to identify and label the various environmental objects surrounding the refuse vehicle 10. For example, the vehicle awareness system 500 may include processing circuitry to identify a fence proximate a road the refuse vehicle 10 is travelling on. The vehicle awareness system 500 may identify the fence using one or more machine learning architecture, including various layers and functions. Once identified, the vehicle awareness system 500 may store associated information with the identified object, including a label the object, in a database or memory for transmission to one or more subsystems (e.g., a trajectory planning system) of the autonomy system.

In addition to perceiving the environment surrounding the vehicle and processing the received sensor data, the vehicle awareness system 500 may sense and record various operating parameters and data relating to the refuse vehicle 10. For example, the vehicle awareness system 500 may determine and record a position and orientation (and associated movement) of the refuse vehicle 10. By way of example, the vehicle awareness system 500 may record adjustments made manually or autonomously to the vehicle when traveling down a narrow alley. These adjustments may be recorded and/or transmitted to a trajectory planning system (e.g., the trajectory planning system 610 of FIG. 5) to be used in planning a future trajectory of the vehicle (e.g., a trajectory for the refuse vehicle 10 to travel in a forward or reverse direction).

The vehicle awareness system 500 may additionally or alternatively perceive and identify bounds and thresholds non-drivable surfaces. For example, the vehicle awareness system 500 may identify non-drivable bounding areas surrounding the identified non-drivable surfaces. These non-drivable bounding areas may be transmitted to the trajectory planning system (e.g., the trajectory planning system 610 of FIG. 5) to use in planning a trajectory for the refuse vehicle 10. The non-drivable bounding areas may be areas in which the refuse vehicle 10 would collide into an identified obstacle. Additionally, or alternatively, the bounded non-drivable surfaces may be areas that the vehicle awareness system 500 determines are illegal or suboptimal for the refuse vehicle 10 to travel in. Likewise, the vehicle awareness system 500 may process the received sensor data to determine and identify bounded drivable areas associated with drivable surfaces. Bounded drivable areas may include legal surfaces upon which the refuse vehicle 10 may travel. In addition, bounded drivable areas may include areas in 3D space that the refuse vehicle 10 can travel without colliding into an object (or can travel with a sufficient safety threshold between the refuse vehicle 10 and an obstacle or other bounded non-drivable surface). Both bounded non-drivable areas and bounded drivable areas may be 2D-bounded areas on a surface or may be 3D-bounded areas in 3D space. In addition to determining and identifying non-drivable bounding areas and bounded drivable areas, the vehicle awareness system 500 may determine and/or identify safety thresholds associated with the non-drivable surfaces or non-drivable bounding areas. These safety thresholds may also be transmitted to the trajectory planning system. The safety thresholds may be associated with a drivable or non-drivable surface and may correspond to an extreme position in 3D space where the refuse vehicle 10 may safely be located. The safety threshold may correspond to a position proximate (or near proximate) the identified non-drivable bounding area and provide a safety buffer for the refuse vehicle 10 from entering the non-drivable bounding area. The safety threshold may correspond with a location on the drivable surface that a tractive element of the refuse vehicle 10 may be positioned. Additionally, or alternatively, the safety threshold may be a location or area in 3D space. For example, the vehicle awareness system 500 may identify a safety threshold around a branch hanging over a drivable surface. In such an embodiment, the refuse vehicle 10 may collide with the overhanging branch while driving on a drivable surface. As such, a safety threshold is provided to avoid the collision. The safety threshold may be used in planning the trajectory and/or in operating the refuse vehicle 10.

The vehicle awareness system 500 may use various sensor data from the disclosed sensors to perceive the environment. Additionally, or alternatively, the vehicle awareness system 500 may process the received sensor data from the sensors to identify the non-drivable bounding areas, non-drivable surfaces, drivable surfaces, objects, etc.

### Autonomous Refuse Collection

The refuse vehicle 10 may also have an autonomous refuse collection system (e.g., an autonomy system, etc.) for executing autonomous/semi-autonomous refuse collection, the system having various components and subsystems, including any such components or subsystems as described with respect to the control system 400 or the autonomous driving system 600. The autonomous refuse collection system may autonomously or semi-autonomously assist in refuse collection operations, such as detecting a refuse can, aligning the refuse vehicle 10 or components of the refuse vehicle 10 with the refuse can, grabbing the refuse can, lifting the refuse can, and dumping the refuse from the refuse can into the refuse vehicle 10. For example, the autonomous refuse collection system may fully autonomously detect a refuse can at a pick-up location, align the grabber assembly of the vehicle 10 with the refuse can, guide the grabber assembly to grab the refuse can, and instruct the lift assembly to lift the refuse can and perform dumping operations. After the dumping process, the autonomous refuse collection system can instruct the lift assembly to lower and replace the refuse can to the pick-up location, and signal to the control system 400 that refuse collection operations have been completed and the refuse vehicle 10 may proceed to the next location.

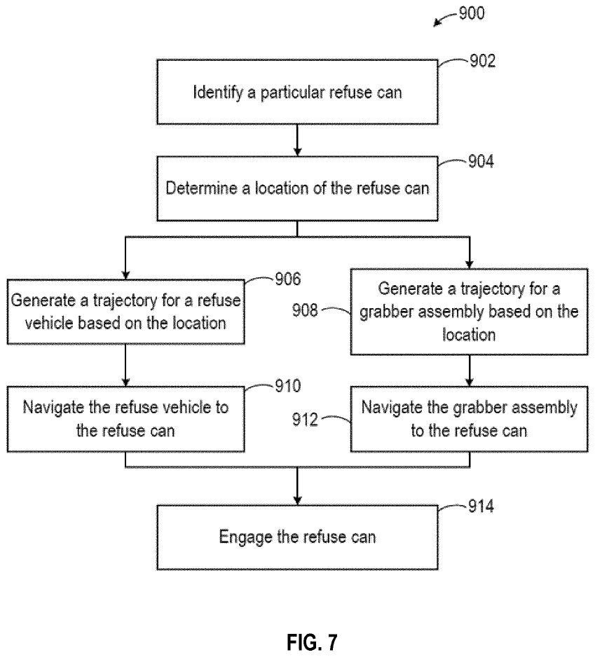

Referring now to FIG. 7, a process 900 for initiating control actions based on a detected refuse can is shown, according to some embodiments. Process 900 may be implemented in response to detecting an object such as a refuse can. Process 900 may be implemented by a controller of a refuse vehicle (e.g., the refuse vehicle 10), such as the controller 401, described above. As denoted herein, an actuator assembly may refer to any type of grabber and/or lift assembly configured to engage and empty a refuse can into a refuse can of a refuse vehicle. For example, the actuator assembly may be the lift assembly 100 or the lift assembly 200, as described above.

At step 902, a particular refuse can is identified. As described above, multiple objects including multiple refuse cans may be detected. In order to initiate a control action, a particular refuse can may be identified, either automatically or based on a user input. In the first case, where a particular refuse can is automatically identified in order to initiate a control action, a controller (e.g., the controller 401) may implement a number of parameters for identifying the particular refuse can. For example, the refuse can may be identified based on identifying features (e.g., size, color, shape, logos or markings, etc.) or may be selected based on its proximity to the refuse vehicle (e.g., the closest refuse can may be identified first). The particular refuse can may be automatically identified in autonomous operations (e.g., where refuse vehicle 10 is autonomous) in order to reduce or eliminate operator input.

In some embodiments (e.g., semi-autonomous or non-autonomous operations), the particular refuse can may be selected by an operator. As described above, for example, the operator may be presented with a user interface for viewing captured data (e.g., image data) and identified objects. The operator may select, from the user interface, the particular refuse can in order to initiate collection of the particular refuse can.

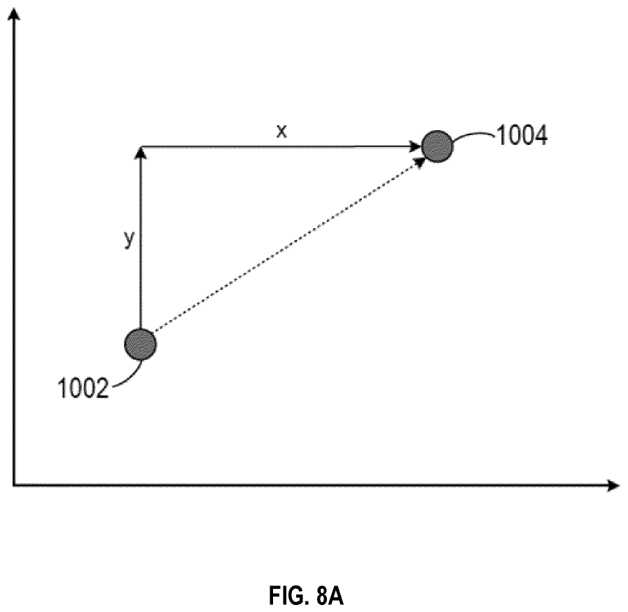

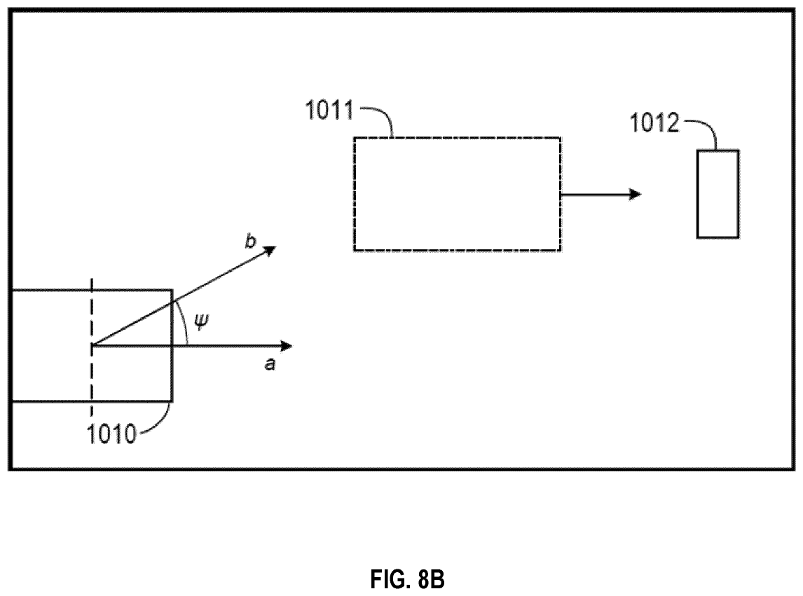

At step 904, a location of the identified refuse can is determined. In some embodiments, the location of the refuse can may be determined based on the location of the refuse vehicle, such that the location of the refuse can is determined relative to the refuse vehicle. In some embodiments, sensor data from image/object sensors 430 may be used to determine the location of the detected refuse can. For example, data from LIDAR or radar sensors may be used to determine a location of the refuse can, and/or may be used to supplement other data (e.g., from a visible light camera). The determination of a location of a detected refuse can is described in further detail below, with respect to FIG. 8A.

At step 906, a trajectory is generated for the refuse vehicle based on the location of the refuse can. The trajectory of the refuse vehicle, for example, may indicate a path or a set of movements for the refuse vehicle to follow to move to align with the refuse can such that the actuator assembly may move to engage the refuse can. For refuse vehicles without a grabber assembly, for example, the trajectory may indicate a path or movements to align the refuse vehicle with the refuse can (e.g., head-on) such as to engage the refuse can with a fork assembly. For refuse vehicles with a grabber assembly, the trajectory may indicate a path or movements to move the refuse vehicle alongside the refuse can (e.g., to engage the refuse can with the grabber assembly). The generation of a trajectory of the refuse vehicle is described in further detail below, with respect to FIG. 8B.

At step 908, a trajectory is generated for an actuator assembly of the refuse vehicle. In some embodiments, step 908 occurs simultaneously with step 906. In other embodiments, step 908 occurs prior or subsequently to step 906. The trajectory of the actuator assembly may indicate a path or a set of movements that the actuator assembly may follow to engage the refuse can once the refuse vehicle has moved alongside the refuse can. In some embodiments, such as with a side loading refuse vehicle, or a refuse vehicle with a grabber assembly, the trajectory may indicate a series of movements lateral, longitudinal, and/or vertical movements that the grabber assembly may follow to retrieve a refuse can. In other embodiments, such as refuse vehicles without a grabber assembly, the trajectory may indicate only longitudinal and/or vertical movements that the grabber assembly may follow to retrieve a refuse can.

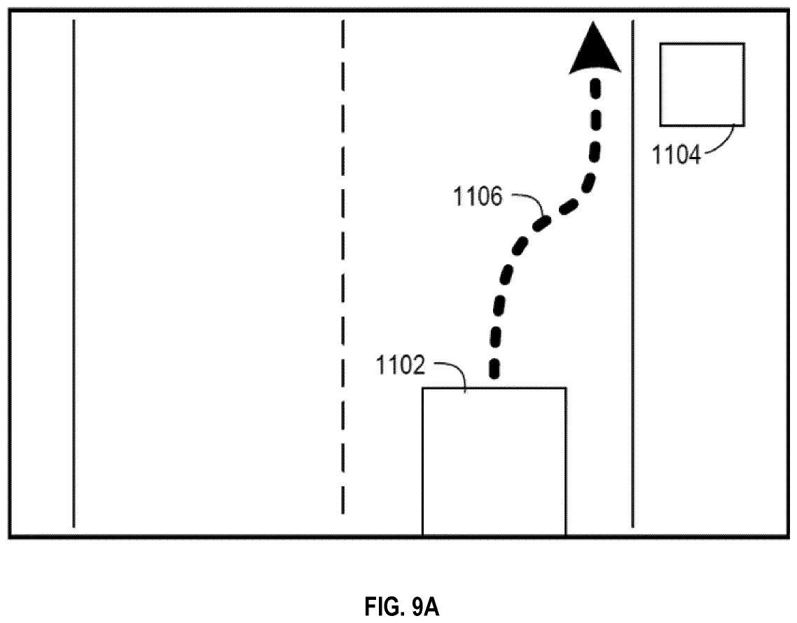

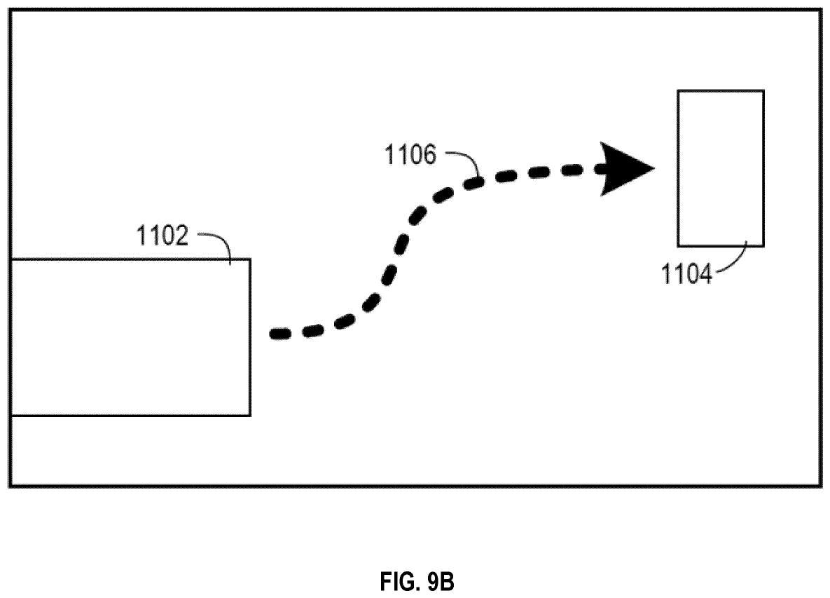

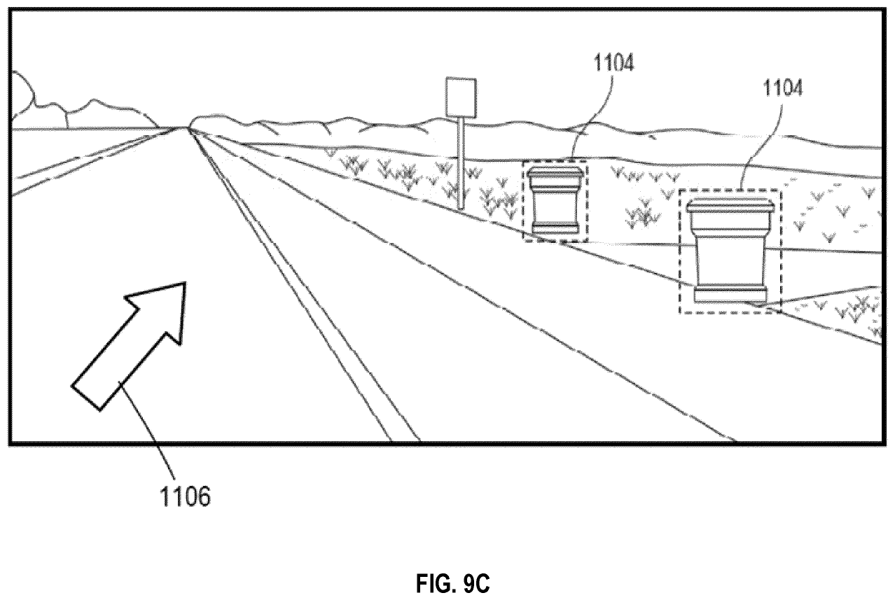

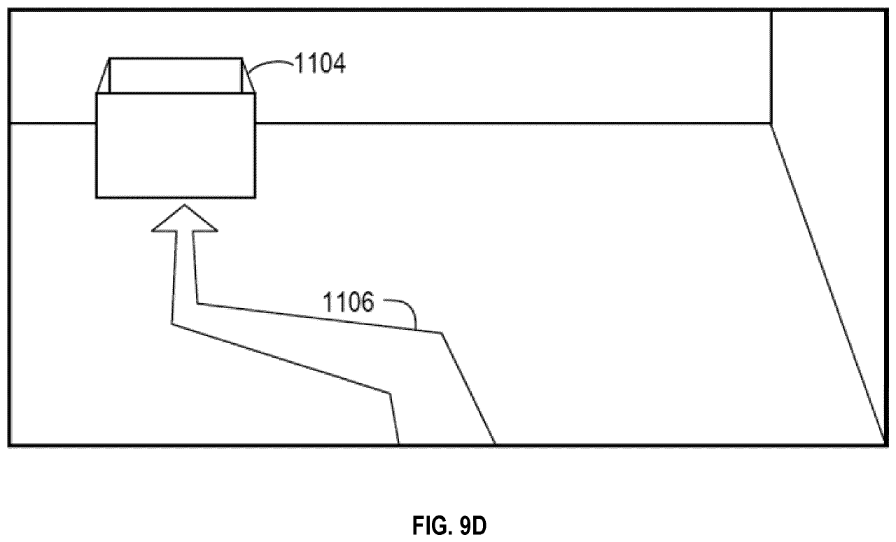

At steps 910 and 912, the refuse vehicle and actuator assembly navigate (e.g., move) to the refuse can. As with steps 906 and 908, steps 910 and 912 may occur simultaneous or concurrently. In autonomous and/or semi-autonomous operations, the refuse vehicle (e.g., refuse vehicle 10) and actuator assembly (e.g., actuator assembly 436) may be controlled or commanded (e.g., by control module 424) to automatically navigate to the refuse can. For example, the refuse vehicle may automatically move to the refuse can, and the actuator may automatically move to engage the refuse can, without operator input. In other embodiments, the trajectories generated at steps 906 and 908 may be presented to the operator (e.g., via a user interface) so that the operator may navigate the refuse vehicle and/or the actuator to the refuse can. As an example, the trajectories may be presented via a user interface, indicating a path and/or movements that the operator should follow to navigate to the refuse can, as shown in FIGS. 9A-9D below.

In some embodiments, as the refuse vehicle and/or the actuator assembly navigate (e.g., move) towards the refuse can, image data and/or sensor data may be captured from the various subsystems of the refuse vehicle (e.g., vehicle systems 434) and/or from the actuator assembly (e.g., actuator assembly 436). The captured image and/or sensor data may be transmitted to feedback module 426 in order to improve, modify, and/or otherwise adjust the movements of the refuse vehicle and/or actuator assembly. As described above, feedback module 426 may include a RNN for processing feedback data. As an example, feedback module 426 may interpret feedback data on the movement of the actuator assembly to adjust the trajectory of the actuator assembly as it moves to engage the refuse can. In another example, a proposed trajectory presented to an operator may be continuously updated to reflect a current position of the refuse vehicle with respect to the refuse can, as the refuse vehicle moves.

At step 914, the refuse can is engaged by the actuator assembly. The refuse can may be engaged by moving the actuator assembly in any suitable direction to engage and lift the refuse can. In some embodiments, such as with a refuse vehicle with a grabber assembly, the actuator assembly may move laterally, longitudinally, and/or vertically to engage the refuse can. In other embodiments, such as refuse vehicles without a grabber assembly, the actuator assembly may only move longitudinally and/or vertically to engage the refuse can. Once the actuator assembly has secured the refuse can (e.g., by closing actuators, by inserting a fork assembly, etc.), the actuator assembly may lift the refuse can to empty the contents of the refuse can into a refuse compartment (e.g., refuse compartment 30).

Referring now to FIG. 8A, an example diagram illustrating the determination of a location of a refuse can is shown, according to some embodiments. As described above with respect to step 904 of process 900, for example, a location or position of a refuse can may be determined after the refuse can is detected (e.g., by object detector 420). Also as described above, data from image/object detectors 430 may be used to determine the location of the refuse can with respect to refuse vehicle 10. In some embodiments, any other suitable devices or sensors (e.g., GPS sensors, LIDAR, etc.) may be used to determine a position or location of a target refuse can.

The diagram of FIG. 8A is shown to include a first point 1002 that represents a location (e.g., position) of a refuse vehicle and a second point 1004 that represents a location of the detected refuse can with respect to the refuse vehicle. A dotted (e.g., broken) line is shown between points 1002 and 1004 which indicates a distance (e.g., magnitude) and a direction between points 1002 and 1004 (e.g., the refuse vehicle and the target refuse can). This distance and direction can be represented by a latitudinal (e.g., vertical) and a longitudinal (e.g., horizontal) component, shown as lines x and y. In some embodiments, the x and y components represent a distance the refuse vehicle must move in a corresponding direction or along a corresponding axis to reach the refuse can. Based on the position of the refuse can with respect to the refuse vehicle, a trajectory can be determined to provide means for the refuse vehicle to move to retrieve/engage the refuse can.

Referring now to FIG. 8B, an example diagram illustrating the determination of a trajectory of refuse vehicle 10 based on the determined location of a detected refuse can 1012 is shown, according to some embodiments. More specifically, in the example diagram of FIG. 8B, a trajectory is determined for a front loading configuration of refuse vehicle 10 that is retrieving refuse can 1012 which may be an industrial or commercial refuse can configured to be engaged with a fork assembly. It will be appreciated, however, that similar methods to those described herein may be used to determine a trajectory for any configuration of refuse vehicle 10 (e.g., front loading, side loading, rear loading) to retrieve any type of refuse can.

As shown in FIG. 8B, a first position 1010 of refuse vehicle 10 is shown, and a current trajectory of refuse vehicle 10 is represented by a first arrow a. The current trajectory of refuse vehicle 10 may represent a trajectory that the vehicle would follow if it continued on a current path (e.g., moved forward or longitudinally). A projected trajectory is shown by a second arrow b. The proposed trajectory may indicate a trajectory that refuse vehicle 10 may follow to reach a second position 1011 where refuse vehicle 10 is aligned with refuse can 1012. The second position 1011 is indicated with dotted (e.g., broken) lines. In the second position 1011, as shown in FIG. 8B, refuse vehicle 10 may be aligned with refuse can 1012 such that refuse vehicle 10 may drive substantially forward to engage refuse can 1012. In another example, where refuse vehicle 10 is in a side loading configuration, the second position may be orthogonal or alongside of refuse can 1012 to engage refuse can 1012 from a side of refuse vehicle 10.

In some embodiments, the proposed trajectory is defined by a distance (e.g., magnitude) and a yaw (e.g., angle about a normal axis) that refuse vehicle 10 may follow to reach refuse can 1012. As shown, for example, the yaw is represented by an angle ψ which indicates a number of degrees that refuse vehicle 10 must turn left or right (e.g., with respect to the current trajectory) to reach the second position 1011. In some embodiments, angle ψ may be continuously determined as refuse vehicle 10 moves towards the second position 1011, in line with refuse can 1012. In other words, as refuse vehicle 10 moves toward the refuse can, the proposed trajectory may be continuously determined or updated to reflect a new position of the refuse vehicle.

In some embodiments, a current position of refuse vehicle 10 is continuously updated or determined such that the proposed trajectory is continuously updated or determined. In such embodiment, any number of sensors or devices may be used to determine the trajectory. For example, the position and movement of refuse vehicle 10 may be determined based on GPS sensors, cameras or object sensors (e.g., image/object sensors 420), inertial sensors, etc. In some embodiments, the data from any of these sensors is processed by controller 401 (e.g., by feedback module 426).

In some embodiments, such as when refuse vehicle 10 is a front loading refuse vehicle, the positioning of refuse vehicle 10 with respect to refuse can 1012 may be particularly important. For example, in some cases, such as with front loading refuse vehicles having fork attachments, an actuator assembly may have a limited range of motion in one or more planes. With a front loading refuse vehicle having a fork attachment, for example, the fork attachment may not be able to move left or right (e.g., laterally). In such embodiments, it may be necessary to align refuse vehicle 10 such that refuse vehicle 10 can drive substantially straight forward to engage refuse can 1012. This may minimize operator input, removing or reducing the need for the operator to exit refuse vehicle 10 to manually move refuse can 1012 into position in front of refuse vehicle 10.

Referring now to FIGS. 9A-9D, example user interfaces for presenting the determined trajectory for refuse vehicle 10 are shown, according to some embodiments. These example user interfaces may be generated by a user interface manager, for example, and/or presented via user interface 432 (e.g., to a user of refuse vehicle 10). In various embodiments, these example user interfaces may be an overlay of another user interface, may be presented as via a heads-up display (HUD), may occupy at least a majority of a user interface, or may be presented by any other suitable methods.

It will be appreciated the example interfaces shown are not intended to be limiting and that any suitable interface or graphical elements for presenting similar information may be used. In some embodiments, the example user interfaces of FIGS. 9A-9D may include a variety of other information based on operator preference, operation requirements, etc., such as menus, other graphical elements, operating information, etc. For example, any of the interfaces of FIGS. 9A-9D may include generated images, aerial or satellite imagery, or any other suitable method for generating a user interface.

The example user interfaces shown in FIGS. 9A-9D may be presented to an operator of refuse vehicle 10 to aid the operator in navigating refuse vehicle 10 to a refuse can, such as in semi-autonomous or manual configurations, and/or may illustrate a path taken by refuse vehicle 10 in autonomous configurations (e.g., without operator input). As an example, an example user interface such as the interface shown in FIG. 9A may be presented to guide the user in navigating refuse vehicle 10. In this example, the user may operate refuse vehicle 10 by following the path illustrated on the interface. In semi-autonomous operations, for example, such a user interface may allow the user to view a current or first position of the refuse vehicle 10 and a projected path (e.g., trajectory) before the user determines whether or not refuse vehicle 10 should move along the path autonomously.

In some embodiments, a projected path may be shown as a graphical element 1106. As described above with respect to FIGS. 8A and 8B, the projected path is based on the determined trajectory and may be continuously updated or determined as refuse vehicle 10 moves. As shown in FIGS. 9A and 9B, for example, graphical element 1106 may be an arrow, a line, or any other suitable graphical element for illustrating a proposed path (e.g., trajectory) that refuse vehicle 10 may take to reach a target refuse can. In this example, the target refuse can is shown as a graphical element 1104, while refuse vehicle 10 is shown as a graphical element 1102. FIG. 9A, in particular, illustrates refuse vehicle 10 (e.g., graphical element 1102) traveling down a path (e.g., a two-lane roadway) to engage a refuse can (e.g., graphical element 1104). In this example, graphical element 1106 shows that refuse vehicle 10 may drive forward, turn slightly right to move toward a curb or an edge of the path, and subsequently turn slightly left to a position orthogonal to the refuse can, in order to engage the refuse can via a grabber assembly mounted on the side of the refuse vehicle 10 or attached to an intermediate storage container.

FIG. 9B illustrates a top-down view of refuse vehicle 10, shown again as graphical element 1102, which may follow the path illustrated by graphical element 1106 to engage a front loading refuse can, shown as graphical element 1104. In this example, refuse vehicle 10 may turn slightly left while driving towards the target refuse can and subsequently turn slight right to align with the refuse can. In this example, the proposed path may align refuse vehicle 10 with the refuse can such that refuse vehicle 10 may drive substantially straight forward to engage the refuse can. As described above, proper aligning of refuse vehicle 10 with a target refuse can may be particularly critical to reduce or eliminate manual intervention from an operator.

In some embodiments, a proposed path or trajectory may be shown in another manner. As shown in FIG. 9C, for example, the proposed trajectory may be illustrated by an arrow, shown as graphical element 1106, or other similar graphical element that indicates a direction of travel to an operator of refuse vehicle 10. Graphical element 1106 may be presented as a HUD, for example, where the interface of FIG. 9C illustrates a view of the operator of refuse vehicle 10. In another example, the interface of FIG. 9C may illustrate a virtual reality or augmented reality view from the front of refuse vehicle 10.

As shown in FIG. 9D, a proposed path or trajectory, shown as graphical element 1106, may be presented in a perspective view. As with the interface of FIG. 9C, for example, the interface of FIG. 9D may represent a virtual reality or augmented reality view from the front of refuse vehicle 10. In various embodiments, graphical element 1106 may be presented via a HUD or in another type of user interface. Graphical element 1106 illustrates a project path for refuse vehicle 10 to move forward to engage a front loading refuse can. In this regard, the path illustrated by graphical element 1106 may align the front of refuse vehicle 10 with the refuse can so that the refuse can may be engaged by a fork assembly.

### Controller Priority

A control system for the refuse vehicle 10, such as control system 400, may include the autonomous driving system 600, and/or an autonomous refuse collection system 1201 (e.g., which may be subsystems thereof), where these systems and/or subsystems of the refuse vehicle 10 may be in communication with each other. The autonomous refuse collection system 1201 may autonomously carry out the process 900, as described herein, to collect refuse from a refuse can. The autonomous driving system 600 and the autonomous refuse collection system 1201 may operate in connection or simultaneously with one another. Due to the autonomous nature of the systems, control may switch automatically between the autonomous driving system 600 and the autonomous refuse collection system 1201. For example, as the refuse vehicle 10 approaches a pick-up location, the autonomous driving system 600 may drive the refuse vehicle 10 as close as possible to the refuse can at the pick-up location, until the autonomous refuse collection system 1201 controls (e.g., takes over) the refuse vehicle 10 to guide and/or maneuver the refuse vehicle 10 into the proper positioning to collect the refuse. In some embodiments, the autonomous refuse collection system 1201 may determine that the refuse vehicle 10 is not in a sufficient location (e.g., too far away from the refuse can, at an improper angle to engage the refuse can, etc.) to begin refuse collection operations and may revert control to the autonomous driving system 600 to further maneuver or reposition the refuse vehicle 10.

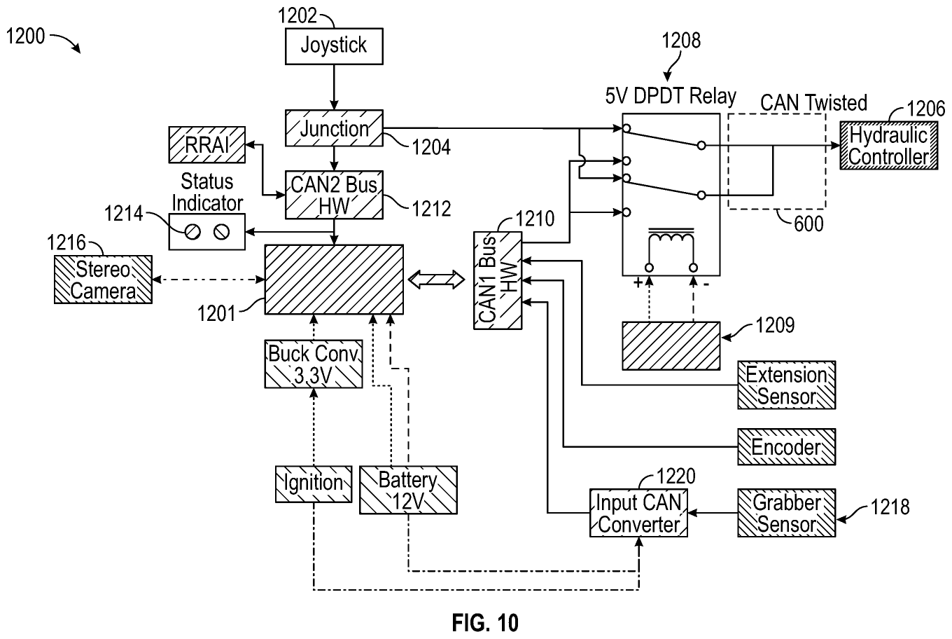

FIG. 10 depicts an embodiment of an electrical architecture diagram, shown as electrical system 1200, including relationships between the components and/or subsystems of the refuse vehicle 10 including an autonomous driving system 600, an autonomous refuse collection system 1201, and a manual control interface 1250 (e.g., an interface to receive and communicate user input). For example, in some embodiments, electrical system 1200 may be included in the control system 400. In some embodiments, the manual control interface 1250 may be or include a joystick 1202. In some embodiments, the manual control interface may include the joystick 1202 and/or other user input mechanisms (such as buttons, triggers, levers, voice receivers, dials, etc.). In some embodiments, the joystick 1202 may include one or more inputs (e.g., user inputs), such as one or more buttons, a trigger, a ball-and-socket mechanism for motion detection, etc. The joystick 1202 may be used to initiate manual operation and/or manually operate the refuse vehicle 10 and/or the various components and/or subsystems of the refuse vehicle 10.

For example, the autonomous driving system 600 controls the refuse vehicle 10 to drive to the pick-up location, where the autonomous refuse collection system 1201 controls the refuse vehicle 10 to guide and/or maneuver the refuse vehicle 10 and/or lift assembly 200 thereof into the proper positioning to collect the refuse. In some embodiments, an operator of the refuse vehicle 10 may control the refuse vehicle 10 and/or the various components and subsystems of thereof (e.g., if there is a fault in the autonomous control systems, if the operator desires to manually control the refuse vehicle 10, etc.). For example, once the autonomous driving system 600 drives the refuse vehicle 10 as close as possible to the refuse can at the pick-up location, the operator of the refuse vehicle 10 may take over control of the refuse vehicle 10 to guide and maneuver the refuse vehicle 10 to collect the refuse (e.g., to make adjustments based on user input provided and/or determined by the operator). For another example, the operator of the refuse vehicle 10 may take control of driving the refuse vehicle 10 from the autonomous driving system 600. The operator may maneuver the refuse vehicle 10 to the pick-up location and position the refuse vehicle 10 into a position to begin collecting the refuse. The operator may then allow the autonomous refuse collection system 1201 to take control and begin and/or continue the refuse collection process.

The autonomous driving system 600 may receive data signals from the autonomous refuse collection system 1201, and/or the autonomous refuse collection system 1201 may receive data signals from the joystick 1202. In some embodiments, the autonomous driving system 600 may determine a priority between a signal from the joystick 1202 and a signal from the autonomous refuse collection system 1201 (e.g., where the signals may conflict with each other, etc.). The autonomous driving system 600 may determine that the signal from the joystick 1202 is to be prioritized over the signal from the autonomous refuse collection system 1201 (e.g., the operator desires to take control of the refuse vehicle 10, and therefore the signal from the joystick 1202 should be prioritized). For example, in the event of a power loss and/or communications loss to the autonomous refuse collection system 1201, the refuse vehicle 10 and/or a subsystem thereof may be manually controlled by the joystick 1202, such that the autonomous driving system 600 is to prioritize the signal from the joystick 1202. The vehicles, systems, and/or methods and/or processes described herein increase redundancy for determinations made by the autonomous control systems of the refuse vehicle 10, such that the desired control signal may be prioritized to control the refuse vehicle 10. For example, to increase the redundancy of manually overriding control of the refuse vehicle 10 over any autonomous or semi-autonomous systems of the refuse vehicle 10 (e.g., so the manual override is prioritized, and the refuse vehicle 10 is not controlled by the autonomous control system over the manual override).

As shown in FIG. 10, the electrical system 1200 (e.g., the electrical architecture for the control systems) of the refuse vehicle 10 is shown that provides operational redundancies between the joystick 1202, the autonomous driving system 600, and/or the autonomous refuse collection system 1201 of the refuse vehicle 10 (e.g., to provide for the joystick 1202 to have priority to control of the refuse vehicle 10 responsive to certain conditions).

The joystick 1202 and the autonomous refuse collection system 1201 may be electrically (e.g., communicably) coupled to the autonomous driving system 600 and/or to a hydraulic controller 1206 of, or controlled by, the autonomous driving system 600. The hydraulic controller 1206 is configured to control actuation of a lift system 1252 of the refuse vehicle 10 (e.g., where the lift system 1252 may be the lift assembly 200, the grabber assembly 42, etc.). For example, the autonomous driving system 600 may transmit signals to the hydraulic controller 1206 for controlling and/or actuating the lift system 1252 of the refuse vehicle 10, which may be based on the signals transmitted to the autonomous driving system 600 by the autonomous refuse collection system 1201 and/or the joystick 1202.

As shown in FIG. 10, a relay 1208 or another switching device may be connected to (e.g., in between) the autonomous refuse collection system 1201 and/or the joystick 1202 to switch therebetween. For example, the relay 1208 may include and/or be coupled to (e.g., electrically, communicably) a monitoring module 1209 and/or an output of the autonomous driving system 600 to determine when to switch the relay 1208 to connect (e.g., prioritize) control signals from the joystick 1202 and/or the autonomous refuse collection system 1201, depending on commands received from the joystick 1202 and/or signals from the monitoring module 1209. During autonomous operation of the refuse vehicle 10 using the autonomous refuse collection system 1201, the relay 1208 may be electrically coupled to the autonomous refuse collection system 1201 to transmit signals to the autonomous driving system 600 (e.g., the hydraulic controller 1206). For example, if the autonomous refuse collection system 1201 loses power and/or incurs a fault, the monitoring module 1209 may cause adjustment of the relay 1208 to switch connection to the joystick 1202 (e.g., to the autonomous driving system 600) for at least partial manual control of the refuse vehicle 10. The monitoring module 1209 may monitor a signal from the autonomous refuse collection system 1201 to determine when to switch to communicably couple the joystick 1202 directly to the hydraulic controller. For example, when the monitoring module 1209 determines that the signal is indicative of the autonomous refuse collection system 1201 losing power and/or incurring a fault (e.g., monitoring a voltage and/or current transmitted by the autonomous refuse collection system 1201, etc.), the relay 1208 may switch to provide communication between the joystick 1202 and the autonomous driving system 600 and/or the hydraulic controller 1206 (e.g., for manual control of the refuse vehicle 10). It should be noted that the components as shown in FIG. 10 are only an example, and that a greater or fewer number of components may be used in various exemplary embodiments.

The joystick 1202 and/or the autonomous refuse collection system 1201 may be electrically connected to various other components (e.g., the hydraulic controller) within the electrical architecture of the control systems of the refuse vehicle 10. For example, the joystick 1202 and/or the autonomous refuse collection system 1201 may be electrically connected via a CAN twisted pair wire to the hydraulic controller. The joystick 1202 may be connected to a junction point 1204, which may be connected to one or more additional components, such as the autonomous refuse collection system 1201 and/or the hydraulic controller 1206. In some embodiments, one or more intermediate components may be included within electrical connection between the joystick 1202 and the autonomous refuse collection system 1201 and/or the hydraulic controller 1206, such as a CAN bus (e.g., CAN2 bus 1212) and/or the relay 1208 (e.g., a 5V double pole, double throw (DPDT) relay, etc.). Thereby, signals from the joystick 1202 may be selectively received by the autonomous refuse collection system 1201 and/or the hydraulic controller 1206, providing redundant control of the refuse vehicle 10 (e.g., autonomous control via the autonomous refuse collection system 1201, an operator confirming autonomous or semi-autonomous control using the joystick 1202 to autonomous operation via the autonomous refuse collection system 1201, and/or providing manual control via the joystick 1202) responsive to signals received from the joystick 1202 and/or an operational state of the autonomous refuse collection system 1201.

The hydraulic controller 1206 may control certain components of the refuse vehicle 10 (e.g., hydraulic components, such as an actuator within the lift assembly 200 and/or the grabber assembly 42, etc.) and may send and/or receive data signals from the joystick 1202, and/or the autonomous refuse collection system 1201 via the relay 1208. In some embodiments, such as where there may be a loss of power or signal within the autonomous refuse collection system 1201, and/or where a signal from the joystick 1202 may be prioritized over the autonomous refuse collection system 1201 (e.g., operator desiring manual override), the joystick 1202 and the autonomous driving system 600 and/or the hydraulic controller 1206 may communicate directly.

In some embodiments, the joystick 1202 is electrically connected to the relay 1208 via one or more wired connections, for example, through (e.g., from) the junction point 1204. The autonomous refuse collection system 1201 may be electrically coupled to the relay 1208 via a CAN bus (e.g., CAN1 bus 1210), such as via a CAN twisted pair wire. In some embodiments, the autonomous driving system 600 and/or the hydraulic controller 1206 may be connected to the relay 1208 via one or more CAN twisted pair wires. The relay 1208 may be connected to the monitoring module 1209 via a positive and/or negative voltage connection. For example, if the monitoring module 1209 determines that the joystick 1202 is to be prioritized (e.g., if the monitoring module 1209 ceases outputting a voltage via the positive and/or negative voltage connection, such as when the autonomous refuse collection system 1201 loses power and/or experiences a fault), the relay 1208 may switch to receiving a signal from the joystick 1202. In some embodiments, the autonomous driving system 600 may be electrically coupled to and/or communicably coupled to the relay 1208, where the autonomous driving system 600 receives signals from either the joystick 1202 and/or the autonomous refuse collection system 1201 (e.g., based on the configuration of the relay 1208), such that the autonomous driving system 600 communicates said signals to the hydraulic controller 1206 for actuating the lift system 1252 of the refuse vehicle 10 based on the signals from either the autonomous refuse collection system 1201 and/or the joystick 1202.

In some embodiments, the joystick 1202 may be electrically coupled to the autonomous refuse collection system 1201 via the CAN2 bus 1212 (e.g., through the junction point 1204, via one or more wired connections). The CAN2 bus 1212 may electrically (e.g., communicably) connect the joystick 1202 to the autonomous refuse collection system 1201. In some embodiments, the CAN2 bus 1212 is electrically coupled to a status indicator 1214, for example, via a CAN twisted pair wire to. The status indicator 1214 may communicate a status of the autonomous refuse collection system 1201 and/or the joystick 1202 to an operator of the refuse vehicle 10. For example, the status indicator 1214 may communicate a “green” or “operational” status and/or a “red” or “not operational” status. If the autonomous refuse collection system 1201 is not operational, the status indicator 1214 indicates said status to the operator (e.g., where the status indicator 1214 is red), so the operator may manually control the refuse vehicle 10 via the joystick 1202.

The autonomous refuse collection system 1201 may be connected via a Universal Serial Bus 3.0 (USB3) to one or more devices 1216 (e.g., a camera such as a stereo camera, a sensor such as a distance sensor, etc.) configured to determine a presence of the refuse can (e.g., a location, such as a position and/or a distance from the refuse vehicle 10 such that the lift system 1252 may engage the refuse can, etc.). For example, the one or more devices 1216 may be a sensor of the vehicle awareness system 500 and/or the vehicle awareness system 608 (e.g., the radar sensors 510, the camera sensors 520, etc.). The device 1216 may be, for example, a camera which sees the surroundings of the refuse vehicle 10 and provides sensor data to the autonomous refuse collection system 1201 (e.g., where the sensor data is indicative of a position of a refuse can and/or other objects in the surrounding environment, etc.). The one or more devices 1216 may send or receive data to or from the autonomous refuse collection system 1201. In some embodiments, the autonomous refuse collection system 1201 may be connected to one or more voltage converters, an ignition of the refuse vehicle 10, a battery (e.g., a 12V battery, etc.), and/or other power supplying device via a positive and/or negative voltage connection.

As shown in FIG. 10, the CAN1 bus 1210 is communicably coupled to the autonomous refuse collection system 1201 (e.g., connecting the autonomous refuse collection system 1201 to the relay 1208, etc.). The CAN1 bus 1210 may be connected (e.g., via one or more CAN twisted pair wires) to one or more devices 1218 (e.g., a sensor, an encoder, a converter, etc.). For example, an input CAN converter 1220 may receive an analog signal from the ignition or the battery and may be electrically connected to the CAN1 bus 1210 and/or the one or more of the devices 1218 (e.g., a grabber sensor, etc.), such as via a CAN twisted pair wire. The input CAN converter 1220 may receive and transmit the analog signals from the ignition and the battery to the autonomous refuse collection system 1201 to communicate to the autonomous driving system 600 to turn off or to control a shutdown of the autonomous refuse collection system 1201 based on a given battery voltage condition. For example, the input CAN converter 1220 acts as a failsafe in the event that the battery voltage drops.

The electrical architecture, such as shown in FIG. 10, provides for the autonomous driving system 600 and/or the autonomous refuse collection system 1201 to recognize and prioritize data signals from the joystick 1202 via the relay 1208. If an operator of the refuse vehicle 10 moves the joystick 1202 or pushes a button on the joystick 1202 while the autonomous driving system 600 or the autonomous refuse collection system 1201 are operating, one or more of the autonomous driving system 600 and/or the autonomous refuse collection system 1201 may cease operation. For example, if the signal from the joystick 1202 is to be prioritized, the relay 1208 switches to provide input of the signal from the joystick 1202 to the autonomous driving system 600, such that the joystick 1202 is used to control operation of the refuse vehicle 10, and the signal from the autonomous refuse collection system 1201 is not received by the autonomous driving system 600 (e.g., the signal from the autonomous refuse collection system 1201 may be terminated at the relay 1208, such that the autonomous refuse collection system 1201 may at least temporarily cease operation once the joystick 1202 is used to control an operation of the refuse vehicle 10,).

In some embodiment, an operator of the refuse vehicle 10 may be required to provide confirmation of (e.g., initiate) autonomous refuse collection via the autonomous refuse collection system 1201. For example, the operator may press and/or hold the trigger (e.g., a first manual input) on the joystick 1202 to initiate operation of the autonomous refuse collection system 1201. While the autonomous refuse collection system 1201 is operating to collect refuse, an operator of the refuse vehicle 10 may perform another action (e.g., a second manual input) via the joystick 1202, for example, moving the joystick 1202, releasing the trigger, pressing a button, etc., to prioritize manual operation via the joystick 1202 over the autonomous refuse collection system 1201 (e.g., and cease operation thereof). Based on the second manual input, the signal from the joystick 1202 may be prioritized, such that the operation of the refuse vehicle 10 (e.g., refuse collection via the lift system 1252) may be controlled manually. In some embodiments, the relay 1208 may switch to provide the signal from the joystick 1202 (e.g., to the autonomous driving system 600 and/or the hydraulic controller 1206), instead of the autonomous refuse collection system 1201.

For example, once the refuse vehicle 10 is in position near a refuse can, an operator may press and hold the trigger of the joystick 1202 to initiate the autonomous refuse collection system 1201. The relay 1208 enables the autonomous refuse collection system 1201 to take control of the actuators of the hydraulic system of the lift system 1252 (e.g., the lift assembly 200, the grabber assembly 42, etc.). For example, the relay 1208 can switch to a first position responsive to a first signal (e.g., based on the first manual input) from the joystick 1202 indicative of initiation of the autonomous refuse collection system 1201. If the operator provides a second signal, such as the second manual input (e.g., releases the trigger of the joystick 1202 such that the first signal is ceased, provides a signal indicative of movement of the joystick 1202 or another button being pressed on the joystick 1202, etc.) the signal from the joystick 1202 is prioritized, such that control is diverted to the joystick 1202 instead of the autonomous refuse collection system 1201, where the autonomous refuse collection system 1201 may be communicably decoupled from the autonomous driving system 600 and/or the autonomous refuse collection system 1201 ceases operation.

For example, the relay 1208 may be configured to switch to a second position to enable direct control of the lift system 1252 by the joystick 1202 and/or to disable the connection between the autonomous refuse collection system 1201 and the lift system 1252 based on the second signal. Thereby, a redundancy is provided in which the relay 1208 substantially prevents the autonomous refuse collection system 1201 from controlling operation of the refuse vehicle 10 when the operator is manually operating the joystick 1202. The relay 1208 acts as a mechanical failsafe to prevent software or computer error during operation of the autonomous refuse collection system 1201. Thereby, the one or more electrical connections between the autonomous refuse collection system 1201 and the autonomous driving system 600 may be configured to enable a lockout, preventing the autonomous refuse collection system 1201 from operating the refuse vehicle 10 while the operator is manually operating the lift system 1252.

The electrical architecture as shown in FIG. 10 is one exemplary embodiment, and it should be noted that any other electrical architecture may be capable of carrying out the processes described herein, and thereby may alternatively be used.

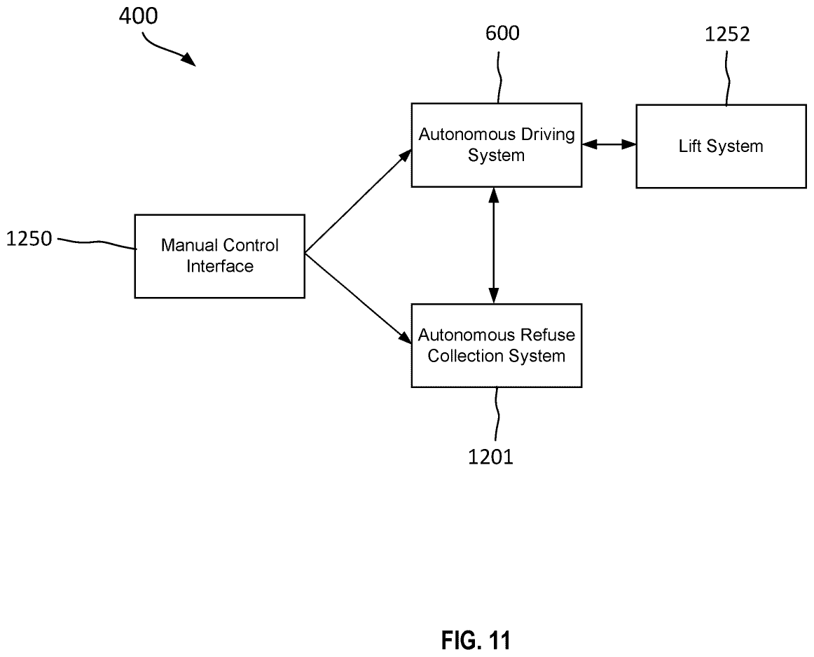

Referring to FIG. 11, another exemplary embodiment of a control system, shown as control system 400, for a refuse vehicle including an autonomous driving system and an autonomous refuse collection system is shown. The control system 400 includes the autonomous driving system 600 and the autonomous refuse collection system 1201, and the manual control interface 1250. The control system 400 provides one or more redundancies for operational control of the refuse vehicle 10 and/or the lift system 1252 thereof. By providing redundancies, the lift system 1252 may be selectively manually controlled, with a reduced risk of error caused by the autonomous driving system 600 operating based on signals from the autonomous refuse collection system 1201 when manual operation using the manual control interface 1250 is desired and/or should be prioritized (and/or during a power loss and/or other fault of the autonomous refuse collection system 1201). Furthermore, and/or in addition to, the control system 400 provides a system check to ensure the autonomous refuse collection system 1201 is not experiencing a fault, based on signals provided by the manual control interface 1250 to the autonomous driving system 600 and/or the autonomous refuse collection system 1201. The manual control interface 1250 is communicably coupled with the autonomous driving system 600 and the autonomous refuse collection system 1201. For example, the manual control interface 1250 may be and/or include the joystick 1202. The autonomous driving system 600 may send and receive signals to the lift system 1252 configured to engage and collect refuse from a refuse can (e.g., refuse can 202), which may include, for example, the hydraulic controller 1206, hydraulic actuators, the lift assembly, etc. (e.g., where the lift system 1252 may be an embodiment of the lift assembly 200, the grabber assembly 42, etc.).

The manual control interface 1250 may send (e.g., transmit) a first signal (e.g., initiation of autonomous refuse collection via the autonomous refuse collection system 1201 providing control signals to the autonomous driving system 600 to control the lift system 1252) to the autonomous driving system 600 and/or the autonomous refuse collection system 1201. For example, the first signal may be transmitted based on a user input (e.g., the first manual input) via the joystick 1202, where the first signal causes initiation of (e.g., requests activation of) the autonomous refuse collection system 1201 (e.g., where the initiation is signaled by pressing and holding the trigger on the joystick 1202). Based on the first signal, the autonomous refuse collection system 1201 may be communicably coupled to the lift system 1252 via the autonomous driving system 600. The autonomous refuse collection system 1201 may be configured to selectively transmit control signals to the autonomous driving system 600 and/or the lift system 1252 (e.g., where the autonomous driving system 600 may receive the control signals and transmit said control signals to the lift system 1252, such as to the hydraulic controller 1206 thereof).

The manual control interface 1250 may send (e.g., transmit) a second signal to the autonomous driving system 600 and the autonomous refuse collection system 1201 (e.g., where the second signal is indicative of desired manual control of the refuse vehicle 10). For example, the second signal may be transmitted based on a second user input (e.g., the second manual input) to the joystick 1202 (e.g., when the trigger has been released, or the joystick 1202 has been moved in another manner or another button has been pressed). Based on the second signal, the autonomous driving system 600 prioritizes control signals from the manual control interface 1250 for the lift system 1252 over control signals from the autonomous refuse collection system 1201. By prioritizing the control signals from the joystick 1202, based on the second signal, the lift system 1252 is manually controlled. Thereby, control of the lift system 1252 is based on the control signals from the joystick 1202, instead of the autonomous refuse collection system 1201, providing a redundancy if the control signals differ and/or conflict with each other (e.g., so the autonomous driving system 600 operates based on the joystick 1202 and not the autonomous refuse collection system 1201, even if signals are received from both). In some embodiments, based on the second signal being received by the autonomous refuse collection system 1201, the autonomous refuse collection system 1201 may cease transmission of control signals (e.g., not send control signals) for to lift system 1252 to the autonomous driving system 600. Thereby, a redundancy (e.g., another redundancy) is provided such that the autonomous driving system 600 cannot operate based on control signals from the autonomous refuse collection system 1201 during manual operation using the joystick 1202, since no control signals are sent from the autonomous refuse collection system 1201. These redundancies decrease the risk of a manual override, such as manual control using the joystick 1202, failing, which thereby may increase the operational performance (e.g., accuracy, speed, energy usage, etc.) of the refuse vehicle 10 collecting refuse via the lift system 1252.

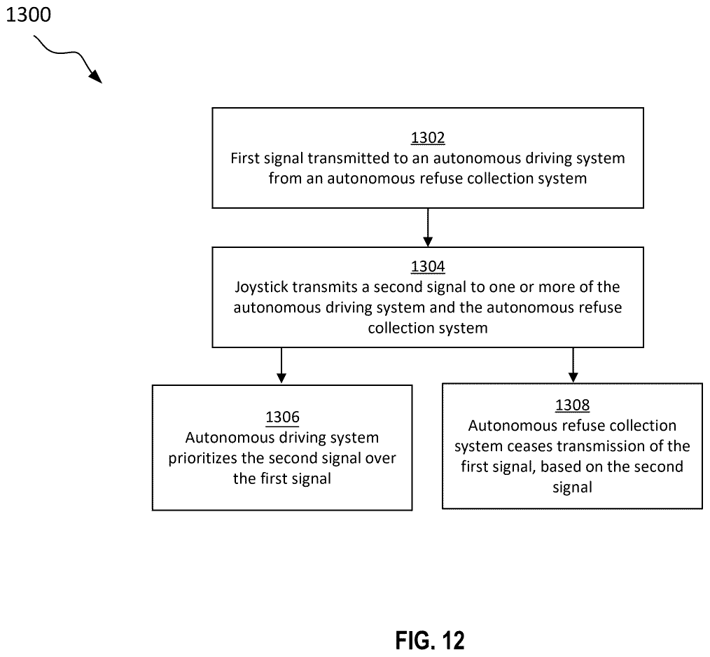

Referring to FIG. 12, a process 1300 (e.g., a method) for signal prioritization is shown. For example, the signal prioritization may be between control signals transmitted by the manual control interface 1250 and the autonomous refuse collection system 1201. The process 1300 may be carried out by an embodiment of the control system 400 and/or using an embodiment of the refuse vehicle 10, as described herein. In some embodiments, process 1300 may include additional, fewer, and/or a different order of method steps.

As shown in FIG. 12, a process 1300 may be implemented by the autonomous driving system 600 and/or the autonomous refuse collection system 1201 for signal prioritization and/or determining control for a lift system, such as onboard a refuse vehicle. At step 1302, the autonomous driving system 600 may receive one or more first signals, such as a signal initiating autonomous operation of the refuse vehicle 10, from the autonomous refuse collection system 1201 (e.g. the first signal is transmitted from the autonomous refuse collection system 1201). For example, the one or more first signals may include an initiation signal for autonomous refuse collection using the lift system 1252 and/or one or more control signals for the lift system 1252 to complete the refuse collection (e.g., engage a refuse can, lift the refuse can, dump the refuse from the refuse can, replace the refuse can on the ground, disengage the refuse can, etc.). The one or more first signals may be transmitted from the autonomous refuse collection system 1201. In some embodiments, the one or more first signals may be transmitted based on a first input from the joystick 1202 (e.g., an operator pulling a trigger, etc.). The joystick 1202 may be communicably coupled to the autonomous refuse collection system 1201 to cause transmission of the first signals (e.g., once the refuse collection process is initiated). Based on receiving the first signal, the autonomous driving system 600 may transmit one or more of the first signals to various components and subsystems of the refuse vehicle 10, such as to the lift system 1252. Thereby, the lift system 1252 may be autonomously controlled by the autonomous refuse collection system 1201 (e.g., based on one or more of the first signals). In some embodiments, the first signal may be transmitted to other components and/or subsystems of the refuse vehicle 10, including, but not limited to, to the driveline of the refuse vehicle 10, the braking system of the refuse vehicle 10, the steering system of the refuse vehicle 10, and/or the alert system of the refuse vehicle 10 (e.g., providing for autonomous control thereof by the control system 400).

At step 1304, one or more second signals may be transmitted from the joystick 1202 to one or more of the autonomous refuse collection system 1201 and/or the autonomous driving system 600 (e.g., the autonomous driving system 600 and/or the autonomous refuse collection system 1201 may receive one or more second signals). For example, the second signals may be transmitted from the joystick 1202 based on a second input of the joystick 1202 (e.g., releasing the trigger, moving the joystick 1202, actuating another button or trigger on the joystick 1202, etc.). The one or more second signals may include one or more control signals for the lift system 1252 to complete the refuse collection (e.g., engage a refuse can, lift the refuse can, dump the refuse from the refuse can, replace the refuse can on the ground, disengage the refuse can, etc.). In some embodiments, the second signal may be transmitted in parallel to both the autonomous driving system 600 and the autonomous refuse collection system 1201 (e.g., the autonomous driving system 600 and/or the autonomous refuse collection system 1201 may receive the second signal simultaneously).

At step 1306, based on the second signal, the autonomous driving system 600 prioritizes the one or more second signals (e.g., received from the joystick 1202) over the one or more first signals (e.g., from the autonomous refuse collection system 1201). By prioritizing the second signal, the refuse vehicle 10 may be manually controlled via the joystick 1202 (e.g., by the operator). At step 1308, the autonomous refuse collection system 1201 may cease transmission of the one or more first signals (e.g., to the autonomous driving system 600), based on the second signal, such that the lift system 1252 is controlled via the one or more second signals. Thereby, by carrying out either of step 1306 and/or step 1308, the lift system 1252 may be controlled manually via the control signals provided by the joystick 1202 (e.g., provided by and/or through the autonomous driving system 600 to the hydraulic controller 1206 of the lift system 1252), without interrupting said lift system control with a different and/or conflicting signal from the autonomous refuse collection system 1201 (e.g., the first signal). If both steps 1306 and 1308 are carried out, multiple redundancies are provided such that the autonomous driving system 600 cannot interrupt control of the lift system 1252 using a different and/or conflicting signal (e.g., the first signal) to the manual control signal (e.g., the second signal) from the joystick 1202, as the autonomous refuse collection system 1201 ceases to provide the first signal when manual control has been established for controlling the lift system 1252.

In some embodiments, a signal from the joystick 1202 may always be prioritized over any other signal, such as the signal from the autonomous refuse collection system 1201, once the signal from the joystick 1202 is received (e.g., by the autonomous driving system 600). For example, if the joystick 1202 transmits a signal (e.g., the operator presses the trigger or a button, or performs a motion of the joystick 1202, etc.), then the hydraulic controller 1206 is manually controlled by the joystick 1202. The autonomous driving system 600 and/or the autonomous refuse collection system 1201 may cease making operational determinations, such as initiating, producing, or transmitting signals (e.g., until the signal from the joystick 1202 is terminated, thereby resuming autonomous control). For example, the autonomous driving system 600 and/or the autonomous refuse collection system 1201 may continually monitor for the signal from the joystick 1202 to determine when to engage in autonomous operation of the refuse vehicle 10 and/or prioritize manual control via the joystick 1202.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the Figures. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general-purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems as shown in the various exemplary embodiments are illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A refuse vehicle comprising:
a chassis;
one or more tractive elements rotatably coupled to the chassis;
a prime mover configured to power the one or more tractive elements to drive the refuse vehicle;
an autonomous driving system configured to control the prime mover;
a body assembly coupled to the chassis, the body assembly defining a refuse compartment;
a lift system configured to collect and deposit refuse into the refuse compartment of the body assembly;
an autonomous refuse collection system configured to generate commands to cause operation of the lift system; and
a controller communicably coupled to the lift system and the prime mover, wherein the controller is configured to:
transmit a first signal to the autonomous driving system of the refuse vehicle to control the lift system, the first signal indicative of initiation of an autonomous refuse collection operation via the lift system to engage and collect refuse from a refuse can;
transmit a second signal from a manual control interface of the refuse vehicle to the autonomous driving system to control the lift system, the second signal indicative of a manual control command for the lift system; and
prioritize, via the autonomous driving system, the second signal over the first signal.

2. The refuse vehicle of claim 1, wherein the controller is further configured to cease transmission of the first signal from the autonomous refuse collection system, based on the second signal.

3. The refuse vehicle of claim 1, wherein the controller is further configured to transmit control signals from the autonomous refuse collection system, based on the first signal, to the lift system to autonomously engage and collect refuse from the refuse can via the lift system.

4. The refuse vehicle of claim 1, wherein the manual control interface is configured to receive a first user input to initiate transmission of the first signal from the autonomous refuse collection system.

5. The refuse vehicle of claim 4, wherein the manual control interface is configured to receive a second user input, different from the first user input, to initiate manual control of the lift system via the manual control interface.

6. The refuse vehicle of claim 1, wherein the manual control interface comprises a joystick configured to operate the refuse vehicle manually.

7. A system, comprising:
an autonomous driving system;
an autonomous refuse collection system;
a lift system;
a manual control interface; and
a controller in communication with the autonomous driving system, the autonomous refuse collection system, the lift system, and the manual control interface, the controller configured to:
receive a first signal from the manual control interface;
based on the first signal, communicably couple the autonomous refuse collection system to the lift system;
receive a second signal from the manual control interface; and
based on the second signal, communicably couple the manual control interface to the lift system while blocking communication between the autonomous refuse collection system and the lift system.

8. The system of claim 7, wherein transmitting the first signal is indicative of initiation of an autonomous refuse collection operation.

9. The system of claim 8, wherein the lift system includes a hydraulic controller, and wherein the autonomous driving system is configured to transmit control signals to the hydraulic controller to actuate the lift system to complete the autonomous refuse collection operation.

10. The system of claim 7, wherein transmitting the second signal comprises one or more control signals to manually control a driveline to manually control the lift system.

11. The system of claim 7, further comprising a relay communicably coupled to the manual control interface, autonomous refuse collection system and the autonomous driving system, the relay configured to switch communication between the autonomous driving system and (i) the autonomous refuse collection system, or (ii) the manual control interface.

12. The system of claim 11, furthering comprising a monitoring module communicably coupled to the relay, the monitoring module configured to cause the relay to switch communication based on the manual control interface transmitting the second signal or a loss of signal from the autonomous refuse collection system.

13. The system of claim 7, further comprising a status indicator communicably coupled to the autonomous refuse collection system, the status indicator configured to indicate an operational status of the autonomous refuse collection system to an operator of the lift system, wherein, based on the status indicator indicating a non-operable status for the autonomous refuse collection system, the manual control interface transmits the second signal via user input from the operator to the manual control interface.

14. A method, comprising:
transmitting a first signal to an autonomous driving system, the first signal indicative of initiation of an autonomous refuse collection operation via a lift system;
transmitting a second signal from a manual control interface to the autonomous driving system, the second signal indicative of manual control of the lift system; and
prioritizing, via the autonomous driving system, the second signal over the first signal.

15. The method of claim 14, further comprising transmitting control signals from an autonomous refuse collection system, based on the first signal, to the lift system to autonomously complete a refuse collection operation.

16. The method of claim 14, further comprising transmitting control signals to the lift system to complete the refuse collection operation, wherein the lift system is manually controlled by the manual control interface based on the second signal.

17. The method of claim 14, wherein transmitting the first signal to the autonomous driving system comprises receiving a first user input via the manual control interface to initiate transmission of the first signal from an autonomous refuse collection system.

18. The method of claim 17, wherein transmitting the second signal from the manual control interface comprises receiving a second user input via the manual control interface, the second user input different from the first user input, the second user input to initiate manual control of the lift system.

19. The method of claim 14, further comprising transmitting the second signal from the manual control interface to the autonomous refuse collection system, wherein the second signal is indicative of manual control of the lift system.

20. The method of claim 19, further comprising ceasing transmission of the first signal from the autonomous refuse collection system, based on the second signal.
